(19) United States
(12) Patent Application Publication
(10) Pub. No.: US 2026/0280822 A1
(43) Pub. Date: Sep. 17, 2026

(54) SIGNALING SOUNDING REFERENCE SIGNAL BANDWIDTH AGGREGATION IN THE NETWORK DURING POSITIONING MEASUREMENT REPORT

(71) Applicant: Telefonaktiebolaget LM Ericsson (publ), Stockholm (SE)

(72) Inventors: Mohammed Yazid LYAZIDI, LONDON (GB); Florent MUNIER, VÄSTRA FRÖLUNDA (SE); Siva MURUGANATHAN, STITTSVILLE (CA); Ritesh SHREEVASTAV, UPPLANDS VÄSBY (SE)

(73) Assignee: Telefonaktiebolaget LM Ericsson (publ), Stockholm (SE)

(21) Appl. No.: 19/472,913

(22) PCT Filed: Apr. 5, 2024
(86) PCT No.: PCT/SE2024/050323

§ 371 Date: Oct. 6, 2025

Related U.S. Application Data
(60) Provisional application No. 63/457,280, filed on Apr. 5, 2023.

(51) Int. Cl. H04L 5/00; H04W 24/08; H04W 64/00

(52) U.S. Cl. CPC H04L 5/0091; H04W 24/08; H04W 64/00

(57) ABSTRACT

A network node (e.g., a location management function (“LMF”) or a gNB-central unit (“gNB-CU”)) can be in a communications network that includes a communication device and another network node. The network node can transmit a first message to the other network node. The first message can include a request to configure the communication device with a request for bandwidth aggregation information. The network node can further receive a second message from the other network node. The second message can include an indication of a bandwidth aggregation identifier (“ID”) and a set of resources associated with the bandwidth aggregation ID.

### TECHNICAL FIELD

The present disclosure is related to wireless communication systems and more particularly to signaling sounding reference signal bandwidth aggregation in the network during positioning measurement report.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

FIG. 2 illustrates an example of NR architecture for supporting NR positioning. In this example, the location node in NR is a location management function (“LMF”). There are also interactions between the location node and the gNodeB via the NR Positioning Protocol A (“NRPPa”). The interactions between the gNodeB and the device is supported via the Radio Resource Control (“RRC”) protocol, while the location node interfaces with the UE via the LTE Positioning Protocol (“LPP”). LPP is common to both NR and LTE. While FIG. 2 shows both a gNB and an ng-eNB, both may not always be present. Further, when both the gNB and the ng-eNB are present, the NG-C is generally only present for one of them.

NR currently supports the following radio access technology (“RAT”) dependent positioning procedures: 1) Downlink time-difference-of-arrival (“DL-TDOA”); 2) Multi-round trip time (“RTT”); 3) Uplink time-difference-of-arrival (“UL-TDOA”); 4) Downlink angle-of-departure (“DL-AoD”); 5) Uplink angle-of-arrival (“UL-AoA”); and 6) NR enhanced cell identifier (“NR-ECID”).

The DL TDOA positioning procedure makes use of the downlink (“DL”) reference signal time difference (“RSTD”) (and optionally DL positioning reference signal (“PRS”) reference signal received power (“RSRP”)) of downlink signals received from multiple transmission points (“TPs”), at the UE. The UE measures the DL RSTD (and optionally DL PRS RSRP) of the received signals using assistance data received from the positioning server, and the resulting measurements are used along with other configuration information to locate the UE in relation to the neighboring TPs.

The Multi-RTT positioning procedure makes use of the UE reception (“Rx”)-transmission (“Tx”) measurements and DL PRS RSRP of downlink signals received from multiple transmission/reception points (“TRPs”), measured by the UE and the measured gNB Rx-Tx measurements and UL sounding reference signal (“SRS”)-RSRP at multiple TRPs of uplink signals transmitted from UE.

The UL TDOA positioning procedure makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The DL AoD positioning procedure makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The UL AoA positioning procedure makes use of the measured azimuth and zenith of arrival at multiple reception points (“RPs”) of uplink signals transmitted from the UE. The RPs measure A-AoA and Z-AoA of the received signals using assistance data received from the positioning server, and the resulting measurements are used along with other configuration information to estimate the location of the UE.

NR-ECID positioning refers to techniques that use additional UE measurements and/or NR radio resource and other measurements to improve the UE location estimate.

The positioning modes can be categorized into three areas: 1) UE-Assisted; 2) UE-Based; and 3) Standalone. UE-Assisted can refer to the UE performing measurements with or without assistance from the network and sending these measurements to the evolved serving mobile location center (“E-SMLC”) where the position calculation may take place. UE-Based can refer to the UE performing measurements and calculating its own position with assistance from the network. Standalone can refer to the UE performing measurements and calculating its own without network assistance.

### SUMMARY

According to some embodiments, a method of operating a second network node in a communications network that includes a communication device and a first network node is provided. The method includes transmitting a first message to the first network node. The first message includes a request to configure the communication device with a request for bandwidth aggregation information. The method further includes receiving a second message from the first network node. The second message includes an indication of a bandwidth aggregation identifier, ID, and a set of resources associated with the bandwidth aggregation ID.

According to other embodiments, a method of operating a second network node in a communications network that includes a communication device and a first network node is provided. The method includes transmitting a third message to the first network node. The third message includes a measurement request for bandwidth aggregation information associated with the communication device and a bandwidth aggregation identifier, ID, indicating a set of resources to be used to determine the bandwidth aggregation information. The method further includes, responsive to transmitting the third message, receiving measurement results including bandwidth aggregation information.

According to other embodiments, a method of operating a first network node in a communications network that includes a communication device and a second network node is provided. The method further includes receiving a first message from the second network node. The first message including a request to configure the communication device with a request for bandwidth aggregation information. The method further includes transmitting a second message to the second network node, the second message including an indication of a bandwidth aggregation identifier, ID, and a set of resources associated with the bandwidth aggregation ID.

According to other embodiments, a method of operating a first network node in a communications network that includes a communication device and a second network node is provided. The method includes receiving a message from the second network node. The message includes a measurement request for bandwidth aggregation information associated with the communication device and a bandwidth aggregation identifier, ID, indicating a set of resources to be used to determine the bandwidth aggregation information. The method further includes performing an aggregation positioning measurement procedure using the set of resources.

According to other embodiments, a method of operating a communication device in a communications network that includes a network node is provided. The method includes receiving a message from the network node. The message includes a request to perform an aggregation positioning measurement procedure and an indication of a bandwidth aggregation identifier, ID associated with a set of resources to be used as part of the aggregation positioning measurement procedure. The method further includes performing the aggregation positioning measurement procedure using the set of resources.

Certain embodiments may provide one or more of the following technical advantages. In some embodiments, an indication of a list of aggregated SRS is provided to LMF to be able to judge the total bandwidth. The LMF can ask the measurements to be done on a specific bandwidth, without asking exactly the SRS resources to the TRP, which will save on signaling and reduce complexity. The TRP/gNB can answer the LMF with the measurement and the list of SRS used for the measurement report.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of NR architecture for supporting positioning in NR;

FIG. 3 is a signal flow diagram illustrating an example of signaling of SRS bandwidth aggregation in a network in accordance with some embodiments;

FIG. 4 is a table illustrating an example of a NRPPa positioning information request message in accordance with some embodiments;

FIG. 5 is a table illustrating an example of an explanation of a condition associated with the NRPPa positioning information request message of FIG. 4 in accordance with some embodiments;

FIG. 6 is a table illustrating an example of a Requested SRS Transmission Characteristics message in accordance with some embodiments;

FIG. 7 is a table illustrating an example of an explanation of a condition associated with the Requested SRS Transmission Characteristics message of FIG. 6 in accordance with some embodiments;

FIG. 8 is a table illustrating an example of an explanation for range bounds associated with the Requested SRS Transmission Characteristics message in accordance with some embodiments;

FIGS. 9-10 are tables illustrating examples of a F1AP positioning information request message in accordance with some embodiments;

FIG. 11 is a table illustrating an example of a SRS Configuration IE in accordance with some embodiments;

FIG. 12 illustrates an example of explanations for range bounds associated with the SRS Configuration IE of FIG. 11 in accordance with some embodiments;

FIG. 13 is a table illustrating an example of a SRS Configuration IE in accordance with some embodiments;

FIG. 14 illustrates an example of explanations for range bounds associated with the SRS Configuration IE of FIG. 13 in accordance with some embodiments;

FIG. 15 is a table illustrating an example of an aggregated SRS Configuration IE in accordance with some embodiments;

FIG. 16 is a table illustrating an example of a measurement request message in accordance with some embodiments;

FIG. 17 is a table illustrating an example of explanations of conditions associated with the Measurement Request message of FIG. 16 in accordance with some embodiments;

FIGS. 18-20 are tables illustrating examples of a positioning measurement request message in accordance with some embodiments.

FIG. 21 is a table illustrating an example explanation of range bounds associated with the positioning measurement request message in accordance with some embodiments.

FIG. 22 is a table illustrating an example explanation of conditions associated with the positioning measurement request message in accordance with some embodiments.

FIG. 23 is a table illustrating an example of a TRP measurement result IE in accordance with some embodiments;

FIG. 25 is a table illustrating an example of a SRS resource type IE in accordance with some embodiments;

FIG. 26 is a flow chart illustrating an example of operations performed by a communication device in accordance with some embodiments;

FIGS. 27-28 are flow charts illustrating examples of operations performed by a network node in accordance with some embodiments.

FIG. 29 is a block diagram of a communication system in accordance with some embodiments;

FIG. 30 is a block diagram of a user equipment in accordance with some embodiments;

FIG. 31 is a block diagram of a network node in accordance with some embodiments;

FIG. 32 is a block diagram of a host, which may be an embodiment of the host of FIG. 29, in accordance with some embodiments;

FIG. 33 is a block diagram of a virtualization environment in accordance with some embodiments; and

FIG. 34 shows a communication diagram of a host communicating via a network node with a user equipment over a partially wireless connection in accordance with some embodiments.

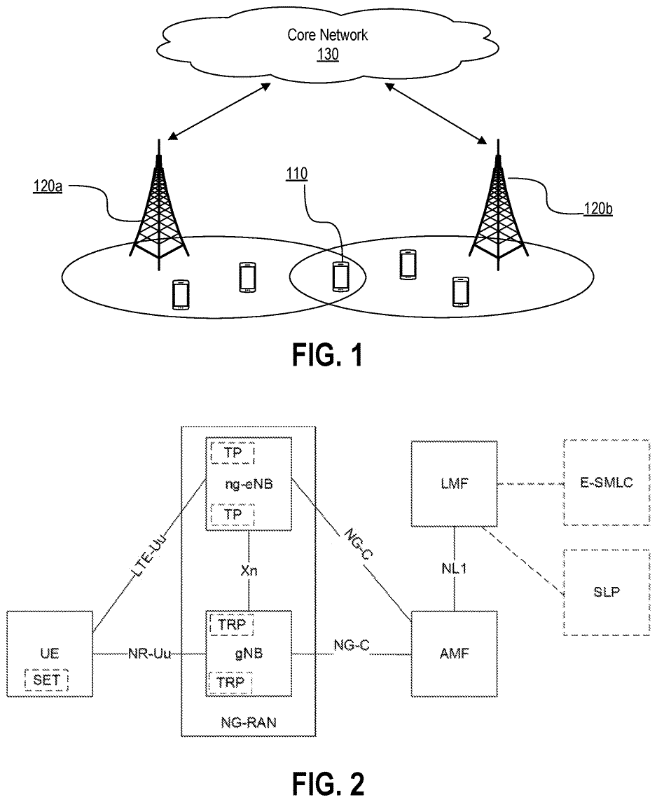

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. It is desired to support sounding reference signal (“SRS”) bandwidth aggregation across two or three carriers and to support enhancement of SRS configuration to indicate the SRS resources from which two or three carriers are linked. Such enhancements need support over NRPPA, the protocol between the positioning server LMF and the NG-RAN, and F1AP the protocol between the gNB-CU terminating NRPPA and the gNB-DU that hosts the TRP. It is currently not clear how the signaling in NRPPA and F1AP will be impacted to support SRS bandwidth aggregation for positioning measurements, when the gNB or TRP report the measurement report to the LMF or gNB-CU, respectively. Hence, the NRPPA and F1AP signaling details is an open issue that needs to be solved.

Certain aspects of the disclosure and their embodiments may provide solutions to these or other challenges. In some embodiments, an Aggregated SRS is defined in the SRS Resource Type IE present in the TRP measurement Result IE of NRPPA and F1AP specification, along with the list the SRS resources used for aggregation. In additional or alternative embodiments, an Aggregation ID is added in the SRS configuration signaled in F1AP and NRPPA to indicate the SRS resources that have aggregated bandwidth linkage.

Various embodiments herein describe the addition of new parameters in NGAP signaling. In some embodiments, during SRS configuration: 1) The LMF requests the gNB-CU via NRPPA message to perform SRS configuration of the UE by using if possible SRS bandwidth aggregation; 2) The gNB-CU requests the gNB-DU via F1AP message to report SRS configuration of the UE by using if possible SRS bandwidth aggregation; 3) The gNB-DU indicates to the gNB-CU in the SRS configuration, the SRS resources, or SRS resources Set that are aggregated, and gNB-CU signals this information to UE over RRC; and 4) The gNB-CU signals the aggregated SRS resources to LMF and the gNB-CU indicates in the SRS configuration, the SRS resources, or SRS resources Set that that have been aggregated via an ID.

In additional or alternative embodiments, during measurement reporting: 1) The LMF indicates over NRPPA message a bandwidth aggregation ID to be used for positioning measurement reporting; 2) The gNB-CU indicates to the TRPs in the gNB-DU over F1AP message the bandwidth aggregation ID to be used for positioning measurement reporting; and 3) The gNB-DU includes in the positioning measurement report whether the positioning measurements have been done using the indicated SRS aggregated bandwidth (e.g., by indicating a flag in the TRP report that is associated to the measurement, or by listing the SRS resources used for this measurement reporting which are part of the aggregated bandwidth).

According to some embodiments, a method of operating a communication device in a communications network that includes a network node is provided. The method includes receiving a message from the network node. The message includes a request to perform an aggregation positioning measurement procedure and an indication of an aggregation identifier, ID associated with a set of resources to be used as part of the aggregation positioning measurement procedure. The method further includes determining the set of resources based on the aggregation ID. The method further includes performing the aggregation positioning measurement procedure using the set of resources.

According to other embodiments, a method of operating a first network node in a communications network that includes a communication device and a second network node is provided. The method includes receiving a message from the second network node. The message includes a request for bandwidth aggregation information associated with the communication device and an aggregation identifier, ID, indicating a set of resources to be used to determine the bandwidth aggregation information. The method further includes performing an aggregation positioning measurement procedure using the set of resources.

According to other embodiments, a method of operating a second network node in a communications network that includes a communication device and a first network node is provided. The method includes transmitting a message to the first network node. The message includes a request for bandwidth aggregation information associated with the communication device and an aggregation identifier, ID, indicating a set of resources to be used to determine the bandwidth aggregation information. The method further includes, responsive to transmitting the message, receiving positioning information associated with the communication device.

According to other embodiments, a communication device, network node, LMF, host, system, computer program, computer program product, or non-transitory computer readable medium is provided to perform one of the above methods.

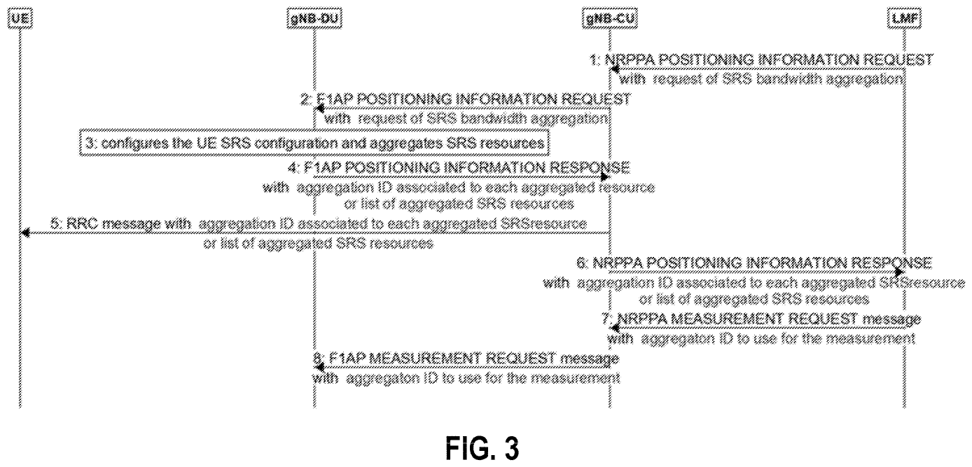

FIG. 3 illustrates an example of signaling of SRS bandwidth aggregation in the network. The received aggregation ID in block 6 is the same used by LMF to indicate the bandwidth aggregation to use in blocks 7-8 for measurement reporting.

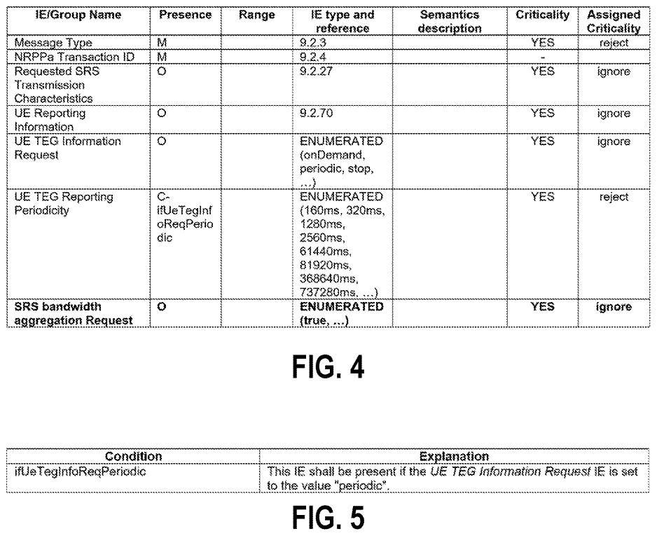

In some embodiments, the LMF indicates a request for SRS bandwidth aggregation in the NRPPA message to the gNB. In some examples, this request for SRS bandwidth aggregation is added as an optional IE/Group name as part of the NRPPA POSITIONING INFORMATION REQUEST message as in 3GPP TS 38.455 v 17.3.0 . An example change needed to section 9.1.1.10 of 3GPP TS 38.455 v 17.3.0 is illustrated in FIG. 4. The positioning information request is a message sent by the LMF to the NG-RAN to request positioning information.

FIG. 5 illustrates an example of an explanation of a condition, ifUETegInfoReqPeriodic.

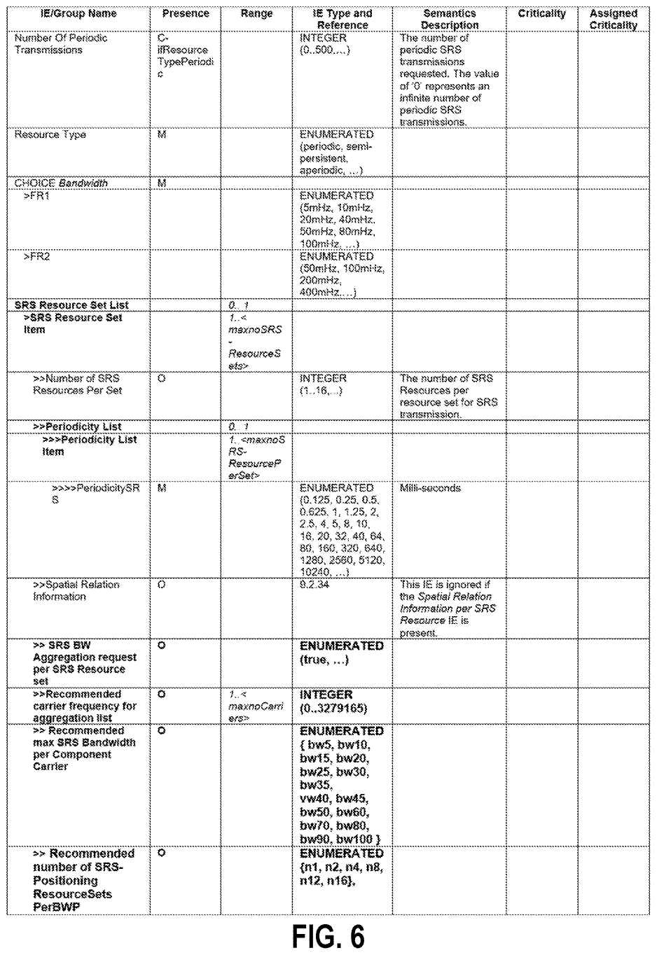

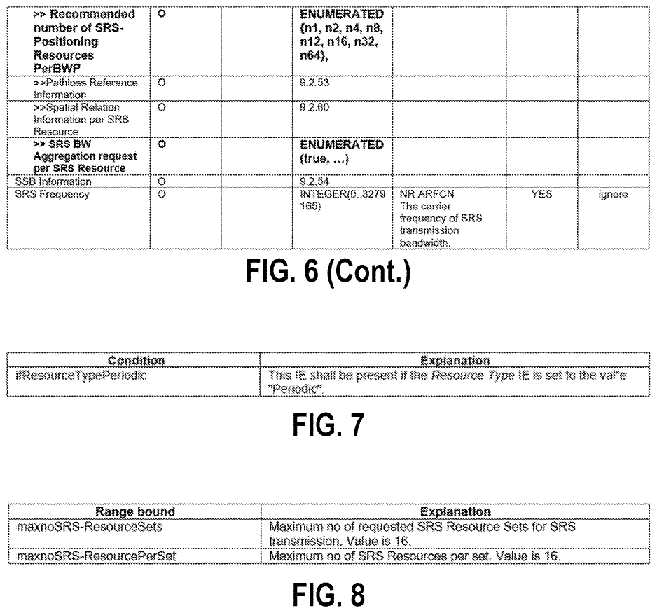

In additional or alternative embodiments, the request for SRS bandwidth aggregation is included as part of the “Requested SRS Transmission Characteristics” IE/Group name in 3GPP TS 38.455 v17.3.0 . Note that the “Requested SRS Transmission Characteristics” is part of the NRPPA POSITIONING INFORMATION REQUEST message in 3GPP TS 38.455 v17.3.0. An example change needed to section 9.2.27 of 3GPP TS 38.455 v17.3.0 is illustrated in FIG. 6. The example below shows the request IEs for “SRS BW Aggregation request per SRS Resource set” and “SRS BW Aggregation request per SRS Resource” which respectively request information regarding the aggregation to be configured for different SRS resource sets and aggregation to be configured for different SRS resources. Two or more SRS resources or SRS resource sets having the same aggregation, indicated by an ID in the response message, are assumed to be configured for SRS bandwidth aggregation. In some example embodiments, only one of the two request IEs may be present as part of “Requested SRS Transmission Characteristics” IE.

In some embodiments, the LMF requests (recommends) specific configuration for SRS BW (carrier) aggregation such as: 1) Frequency Region (e.g. Component Carrier lists, ARFCN lists, BWPs, PRBs); 2) Bandwidth per CC for carrier aggregation; and 3) Number of positioning resource sets and resources per BWP. The LMF decides the above parameter based upon analysis of positioning measurement accuracy that is needed; and can be based upon (knowledge gain, historical information) of the positioning accuracy of another UE which is located nearby the target UE. The information can be also deduced reciprocally based upon any DL-PRS BW aggregation information. If LMF has also configured or previously configured DL PRS carrier aggregation, it can understand which frequency regions were suitable and can recommend spatial UL carrier aggregation. This is suitable for carrier aggregation when multi-RTT procedure is used where both DL and UL carrier aggregation is needed.

The Requested SRS Transmission Characteristics IE includes the requested SRS configuration for the UE.

FIG. 7 illustrates an example of an explanation of a condition, ifResource TypePeriodic.

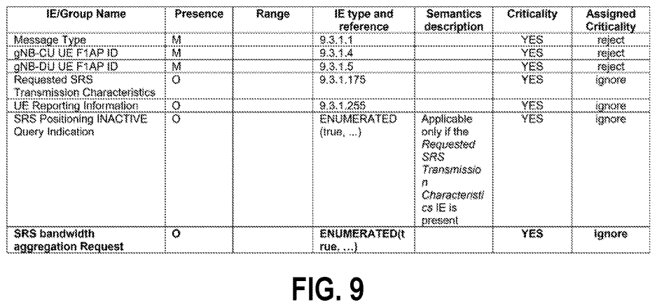

FIG. 8 illustrates an example of an explanation for range bounds, maxnoSRS-ResourceSets and maxnoSRS-ResourcePerSet.

In some embodiments, the gNB-CU indicates a request for SRS bandwidth aggregation in the F1AP message to the gNB-DU. In some examples, this request for SRS bandwidth aggregation is added as an optional IE/Group name as part of the F1AP POSITIONING INFORMATION REQUEST message in 3GPP TS 38.473 v17.3.0 . An example change needed to section 9.1.1.10 of 3GPP TS 38.455 v17.3.0 is illustrated in FIG. 9. This message is sent by the gNB-CU to indicate to the gNB-DU the need to configure the UE to transmit SRS signals for uplink positioning measurement and also to retrieve the SRS configuration from the gNB-DU.

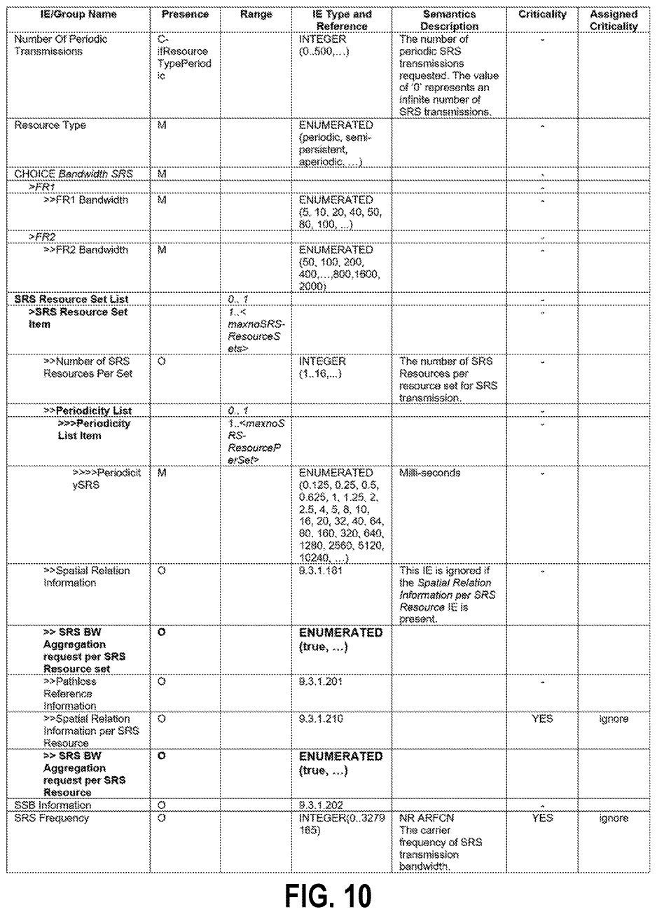

In additional or alternative embodiments, the request for SRS bandwidth aggregation is included as part of the “Requested SRS Transmission Characteristics” IE/Group name in 3GPP TS 38.473 v17.3.0 . Note that the “Requested SRS Transmission Characteristics” is part of the F 1AP POSITIONING INFORMATION REQUEST message in 3GPP TS 38.455 v17.3.0 . An example change needed to section 9.3.1.175 of 3GPP TS 38.473 v17.3.0 is illustrated in FIG. 10. In this example, the request IEs for “SRS BW Aggregation request per SRS Resource set” and “SRS BW Aggregation request per SRS Resource” which respectively request information regarding the aggregation to be configured for different SRS resource sets and aggregation to be configured for different SRS resources. Two or more SRS resources or SRS resource sets having the same aggregation, indicated by an aggregation ID in the response message, are assumed to be configured for SRS bandwidth aggregation. In some example embodiments, only one of the two request IEs may be present as part of “Requested SRS Transmission Characteristics” IE .. This IE includes the requested SRS configuration for the UE for positioning purposes.

In additional or alternative embodiments, after configuring the SRS transmission for the UE, the gNB-DU indicates to gNB-CU which list of SRS resources can be aggregated, by adding an aggregation ID to the SRS resources in the SRS configuration IE present in TS 38.473 v17.3.0 section 9.3.1.192.

In additional or alternative embodiments, the aggregation ID can be associated to an SRS resource, to an SRS Resource Set, to a Positioning SRS resource or to a Positioning SRS Resource Set.

In additional or alternative embodiments, the aggregation ID indicates per SRS resource level when two SRS resources are configured for SRS transmission for BW aggregation.

In additional or alternative embodiments, the aggregation ID indicates per SRS resource set level when two or more SRS resources within the two SRS resources set are configured for SRS transmission for BW aggregation.

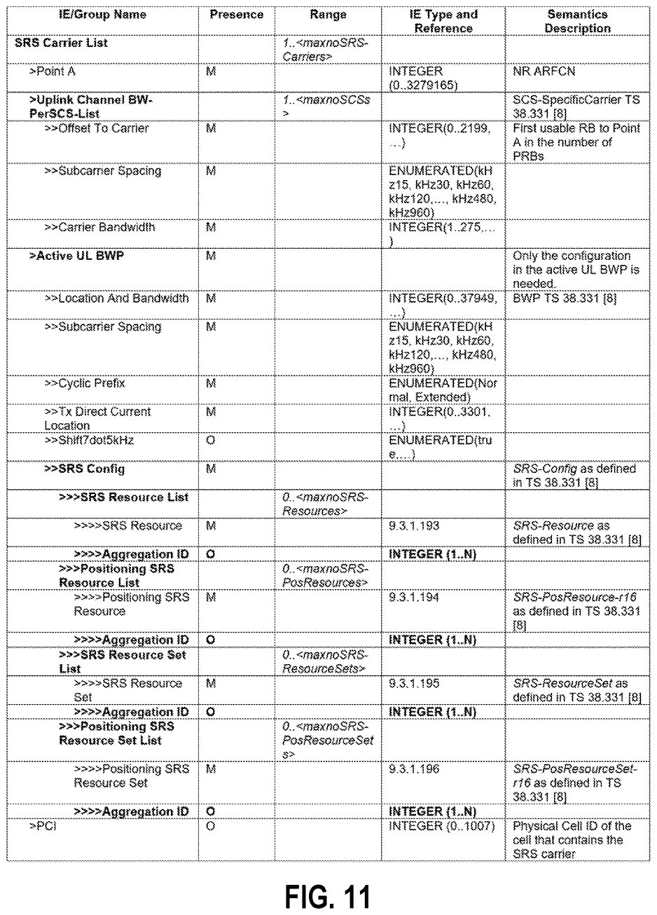

FIG. 11 illustrates an example of such aggregation indication. This SRS Configuration IE includes the SRS configuration configured by the gNB-CU for the UE.

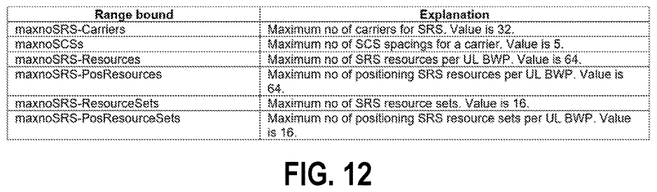

FIG. 12 illustrates an example of explanations for range bounds associated with the SRS Configuration IE of FIG. 11.

In additional or alternative embodiments, after configuring the SRS transmission for the UE, the gNB-CU transmits the information to the LMF indicating which list of SRS resources can be aggregated, by adding an aggregation ID to the SRS resources in the SRS configuration IE present in TS 38.455 v17.3.0 section 9.2.28.

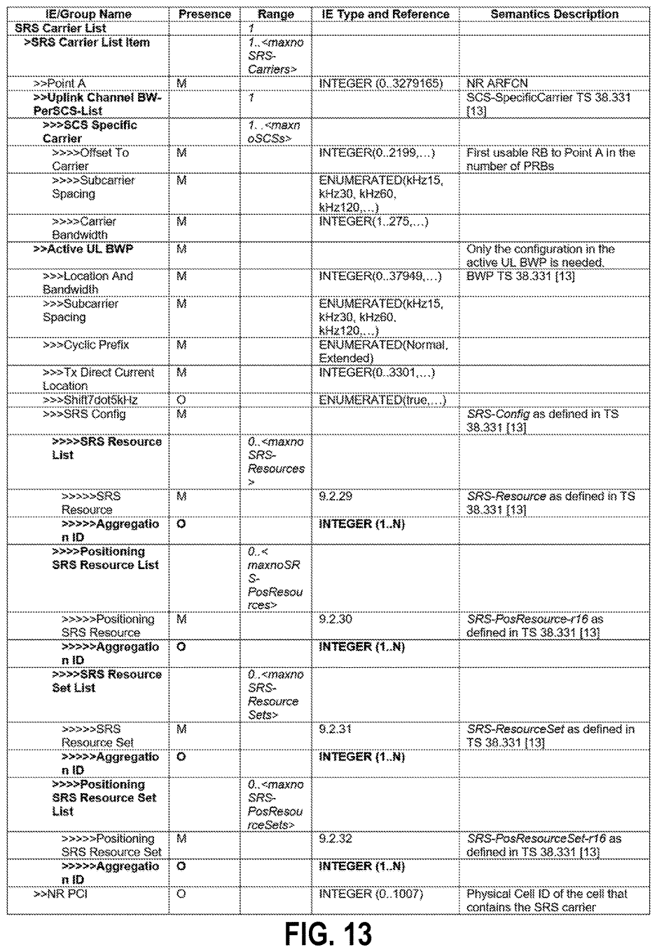

In additional or alternative embodiments, the aggregation ID over NRPPA can be associated to an SRS resource, to an SRS Resource Set, to a Positioning SRS resource or to a Positioning SRS Resource Set. FIG. 13 illustrates an example of such indication. This SRS Configuration IE includes the SRS configuration configured by the NG-RAN for the UE.

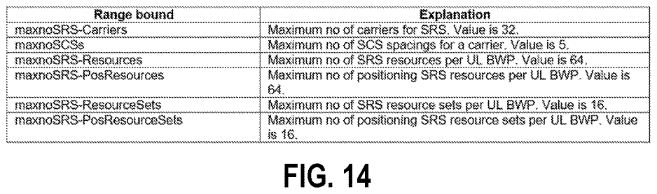

FIG. 14 illustrates an example of explanations for range bounds associated with the SRS Configuration IE of FIG. 13.

In additional or alternative embodiments, an aggregation ID is only associated with SRS resource sets (or Positioning SRS resource sets). Which SRS resources within two SRS resource sets that can be aggregated are defined by one or more criteria predefined in 3GPP specifications including one or more of the following: 1) two SRS resources in the two SRS resource sets can be aggregated if they are configured in the same slot and in same symbol(s) within the slot; (each SRS Resource set and resources that are to be aggregated would be transmitted in separate BWPs simultaneously); 2) the two SRS resources in the two SRS resource sets have the same spatial relation; 3) the two SRS resources have the same number of symbols within the slot; and 4) the two SRS resources have the same numerology and comb size

In additional or alternative embodiments, the SRS configuration includes the srs-aggregation-configuration together with the (non-aggregated) SRS configurations over NRPPA.

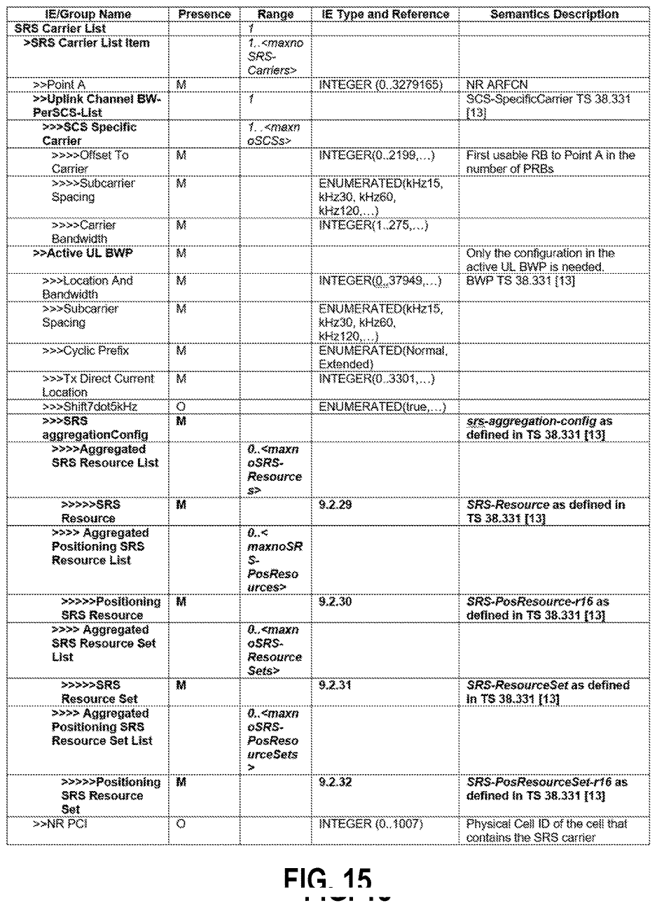

FIG. 15 illustrates an example of an aggregated SRS configuration IE. This information element includes the aggregated SRS configuration configured by the NG-RAN node for the UE.

In additional or alternative embodiments, the srs-aggregation-configuration is signaled together with the (non-aggregated) SRS configurations over F1AP and over RRC to the UE.

Embodiments associated with measurement reporting with bandwidth aggregation is described below. In some embodiments, the LMF triggers a NRPPA message to the gNB to request the UL measurement to be performed on aggregated bandwidth.

In additional or alternative embodiments, the LMF includes the aggregation ID received during the SRS configuration described above in the NRPPA measurement request message. Alternatively, the LMF indicates the SRS aggregation configuration that has been reported from the gNB in the previous step and indicates to use it when reporting positioning measurements.

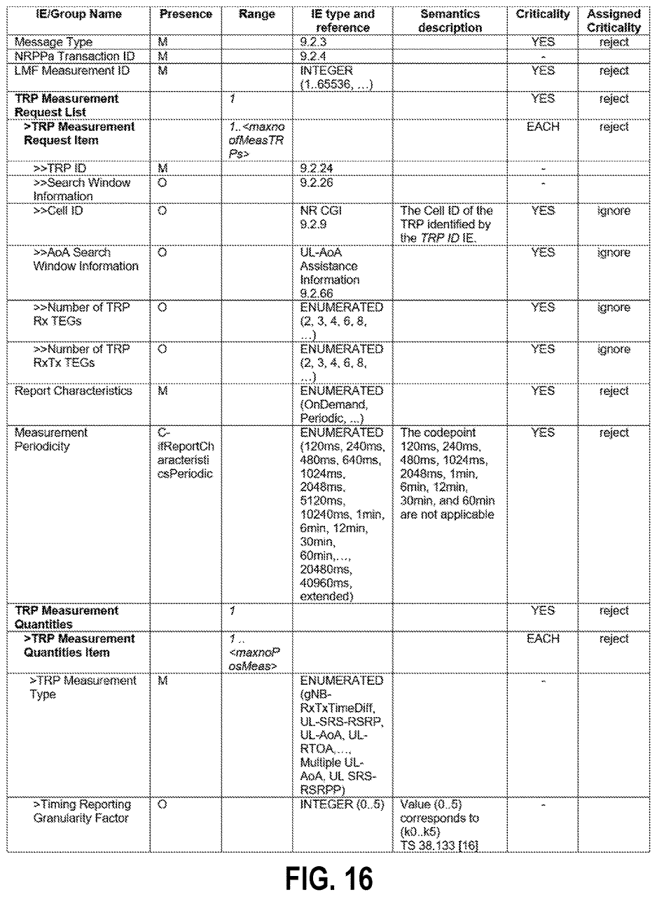

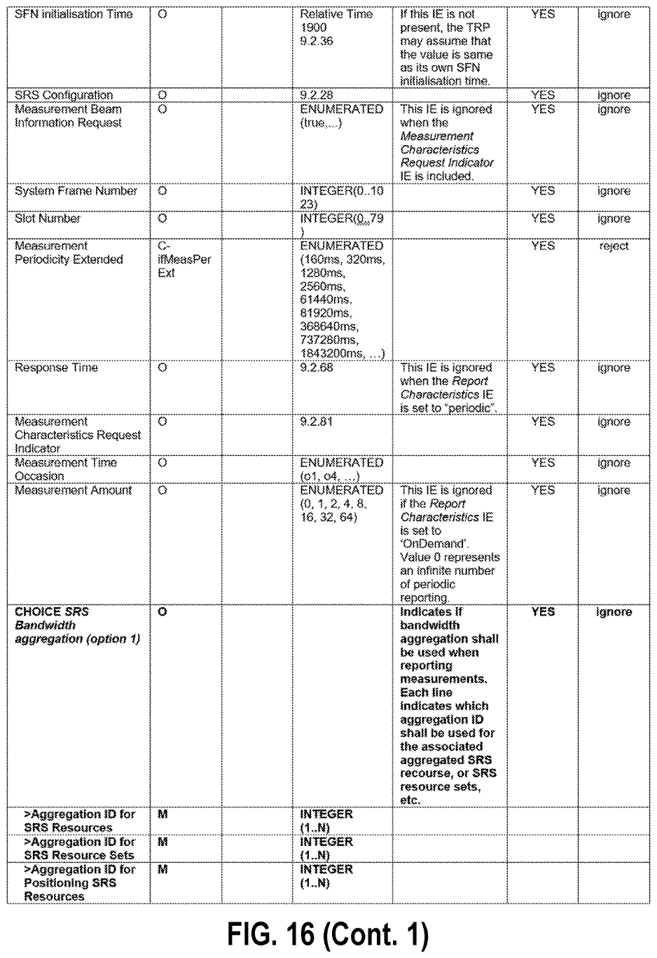

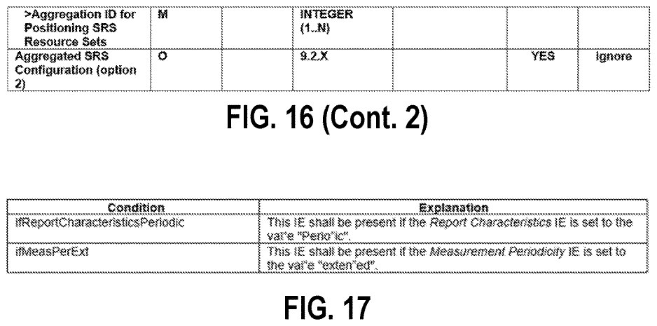

FIG. 16 illustrates an example form TS 38.455 is presented below, with two options. Option 1 is the LMF indicating the aggregation ID to be used in the MEASUREMENT REQUEST message for generating UL positioning measurements. Option 2 is the LMF indicating the SRS aggregation configuration in the MEASUREMENT REQUEST message. This message is sent by the LMF to request the NG-RAN node to configure a positioning measurement.

FIG. 17 illustrates an example of explanations of conditions associated with the Measurement Request message of FIG. 16.

In additional or alternative embodiments, upon receiving the NRPPA message, the gNB-CU triggers a F1AP message to the gNB-DU to request the UL measurement to be performed on aggregated bandwidth.

In some embodiments, the gNB-CU includes the aggregation ID received during the SRS configuration described in above sections in the F1AP measurement request message. Alternatively, the gNB-CU indicates the SRS aggregation configuration that has been reported from the gNB-DU in the previous step and indicates to use it when reporting positioning measurements.

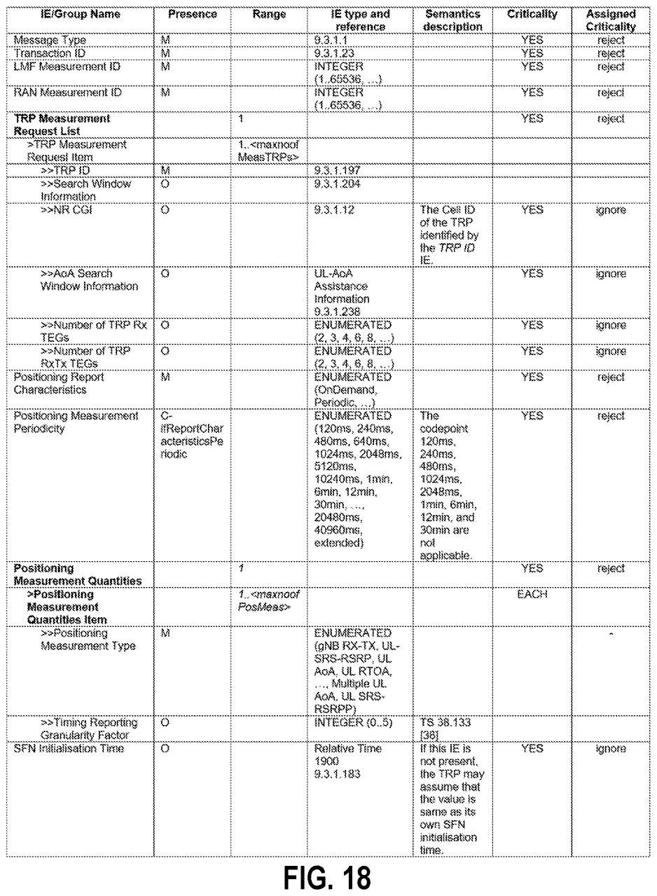

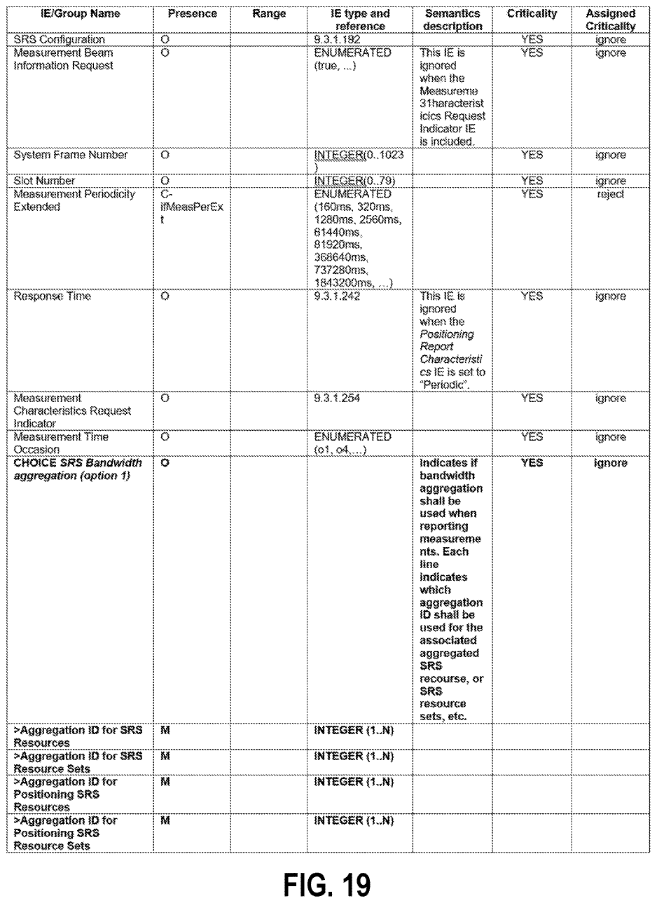

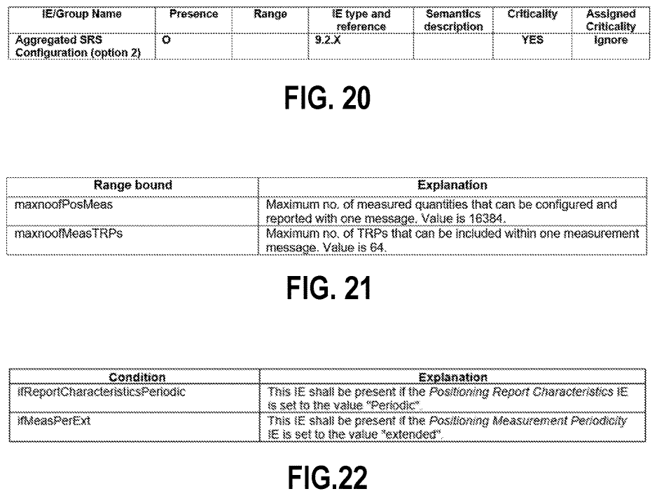

FIGS. 18-20 illustrate an example form TS 38.473, with the two options. Option 1 is the gNB-CU indicating the aggregation ID to be used in the POSITIONING MEASUREMENT REQUEST message for generating UL positioning measurements. Option 2 is the gNB-CU indicating the SRS aggregation configuration in the POSITIONING MEASUREMENT REQUEST message. This message is sent by the gNB-CU to request the gNB-DU to configure a positioning measurement.

FIG. 21 illustrates an example explanation of range bounds associated with the positioning measurement request message. FIG. 22 illustrates an example explanation of conditions associated with the positioning measurement request message.

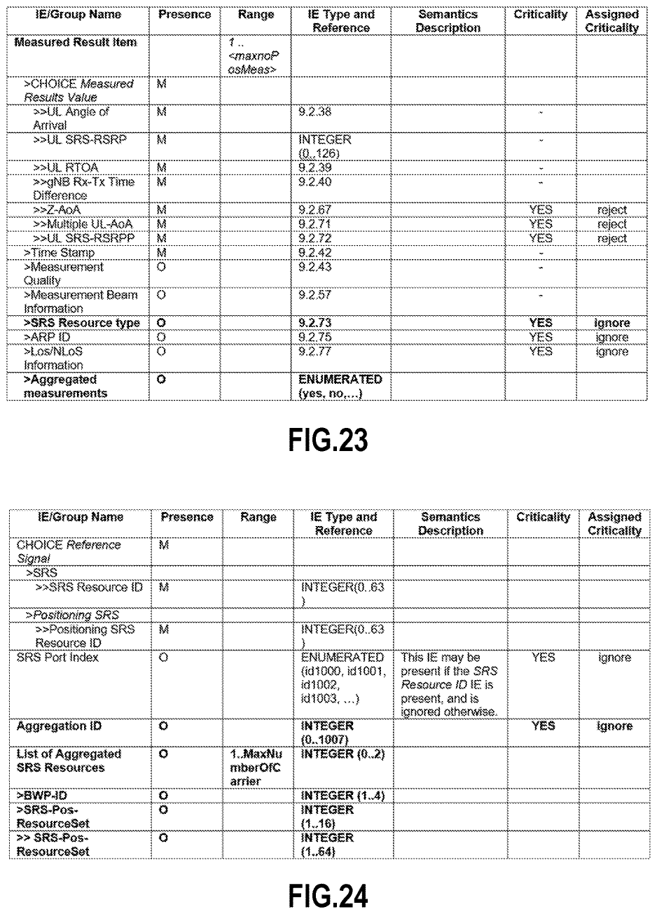

In additional or alternative embodiments, when reporting the UL positioning measurements, an indication of Aggregated SRS is included in the positioning measurement result IE defined in TS 38.473 section 9.3.1.166 and in the TRP Measurement Result IE defined in TS 38.455 section 9.2.37. In one example the aggregation indication is part of the SRS Resource Type IE defined in TS 38.455 and TS 38.473. A non-limiting example to TS 38.455 is illustrated in FIG. 23. The TRP Measurement Result IE includes the measurement result. FIG. 24 illustrates an example of a SRS Resource type IE.

In some embodiments, the possibility of supporting SRS aggregation for a given measurement report relies on two conditions. Firstly, the UE must have signaled the capability for SRS carrier aggregation. Secondly, the UE must have sufficient coverage at the time the measurement is requested to be able to transmit reliably SRS in multiple carrier. In the following embodiment, a solution is described to allow the network to handle the case where SRS aggregation is not feasible at the time of a request coming from the LMF.

In additional or alternative embodiments, during the UE configuration phase, when the SRS bandwidth aggregation Request IE is included in the NRPPA or F1AP POSITIONING INFORMATION REQUEST message and the receiving node is unable to configure aggregated SRS, it may fail the request and send a failure message (NRPPA or F1AP POSITIONING INFORMATION FAILURE message) indicating that configured aggregated SRS could not be supported at the time of request.

In additional or alternative embodiments, when the LMF request for positioning information via NRPPA message (followed by F1AP message to the gNB-DU) it includes information if the LMF would be interested in a positioning configuration or measurement based on a single SRS (i.e. not on SRS aggregation) should the gNB/TRP be unable to allocate resource for SRS aggregation (for example, when the UE coverage is not sufficient for multiple carriers being allocated, but sufficient for single carrier measurement).

In addition lor alternative embodiments, the gNB/TRP response/report based on a LMF request for aggregated SRS measurement can report a single-carrier SRS measurement. Such measurement may be reported when the LMF has indicated that the single carrier measurement would be an acceptable alternative to multicarrier SRS aggregation, as an alternative to positioning message failure being reported.

The failure (fallback) reporting can also be reported by gNB to LMF as below using the SRS Transmission Status. The UE may report the failure (fallback to non aggregated SRS)to gNB using RRC and gNB can report/relay the failure to LMF using below NRPPa (for example). The below can also be used to relay whether UE is currently transmitting SRS using single carrier or aggregated carrier or has fallback from aggregated Carrier to single Carrier for SRS transmission.

This message is sent by NG-RAN node to indicate that a change in the SRS configuration has occurred.

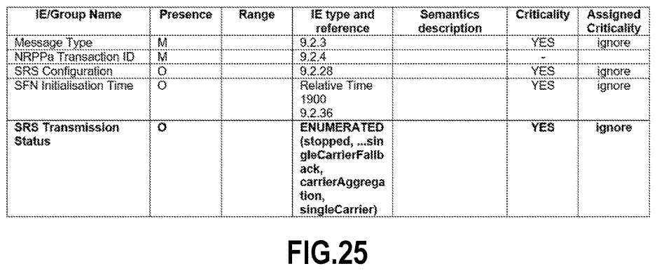

FIG. 25 illustrates an example of a positioning information update message. This message can be sent by the NG-RAN node to indicate that a change in the SRS configuration has occurred.

In additional or alternative embodiments, the receiving node sends the configured SRS resources to the requesting node without any aggregation indication. The LMF will interpret that SRS resources could not configured by the receiver. The measurement request would be done following legacy handling.

In additional or alternative embodiments, the failure of the receiving node to report configuration or positioning measurement with SRS bandwidth aggregation can be indicated as a new cause value in the F1AP and NRPPA messages.

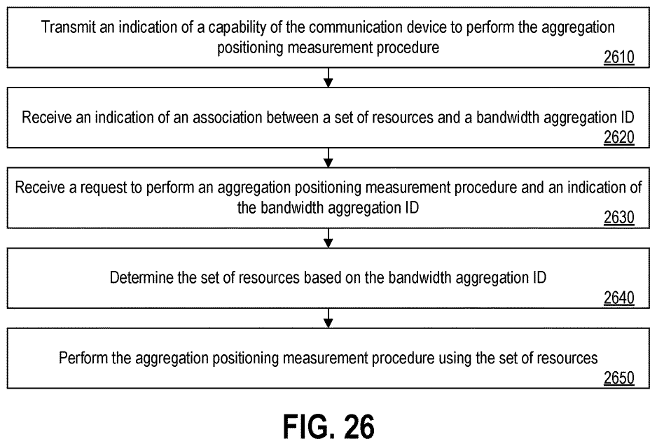

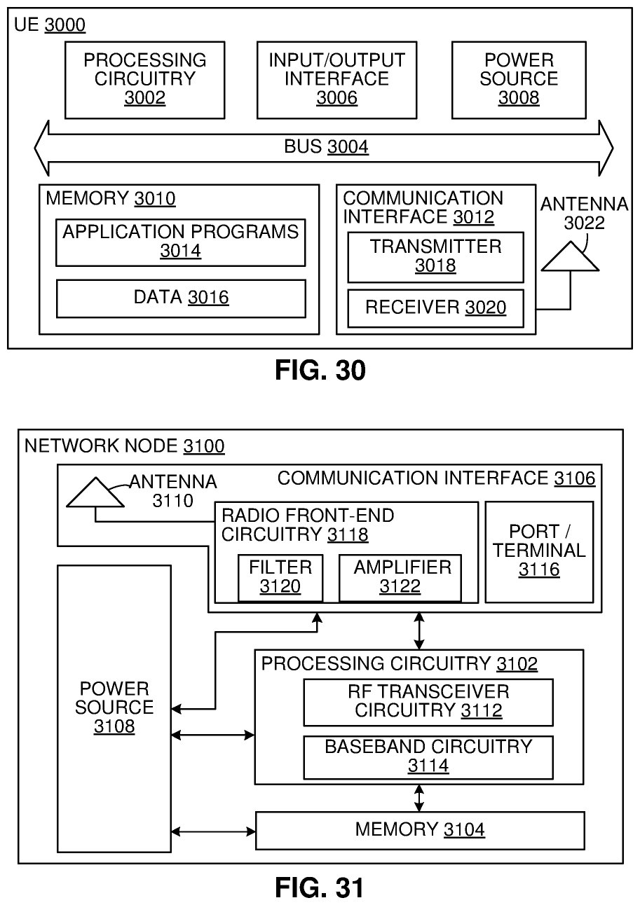

Operations of the communication device 3000 (implemented using the structure of the block diagram of FIG. 30) will now be discussed with reference to the flow chart of FIG. 26 according to some embodiments of inventive concepts. For example, modules may be stored in memory 3010 of FIG. 30, and these modules may provide instructions so that when the instructions of a module are executed by respective communication device processing circuitry 3002, processing circuitry 3002 performs respective operations of the flow chart.

FIG. 26 illustrates an example of operations performed by a communication device in a communications network that includes a network node.

At block 2610, processing circuitry 3002 transmits, via communication interface 3012, an indication of a capability of the communication device to perform the aggregation positioning measurement procedure.

At block 2620, processing circuitry 3002 receives, via communication interface 3012, an indication of an association between a set of resources and a bandwidth aggregation ID (and/or an aggregation ID).

At block 2630, processing circuitry 3002 receives, via communication interface 3012, a request to perform an aggregation positioning measurement procedure and an indication of the bandwidth aggregation ID.

At block 2640, processing circuitry 3002 determines the set of resources based on the bandwidth aggregation ID.

At block 2650, processing circuitry 3002 performs the aggregation positioning measurement procedure using the set of resources. In some embodiments, performing the positioning measurement procedure includes transmitting a plurality of sounding reference signals, SRS, in multiple carriers using the set of resources. In additional or alternative embodiments, performing the positioning measurement procedure includes transmitting positional measurements to a second network node configured to provide a location management function, LMF. In additional or alternative embodiments, performing the positioning measurement procedure includes determining that the communication device will have sufficient coverage to perform the aggregation positioning measurement procedure.

Various operations from the flow chart of FIG. 26 may be optional with respect to some embodiments of communication devices and related methods.

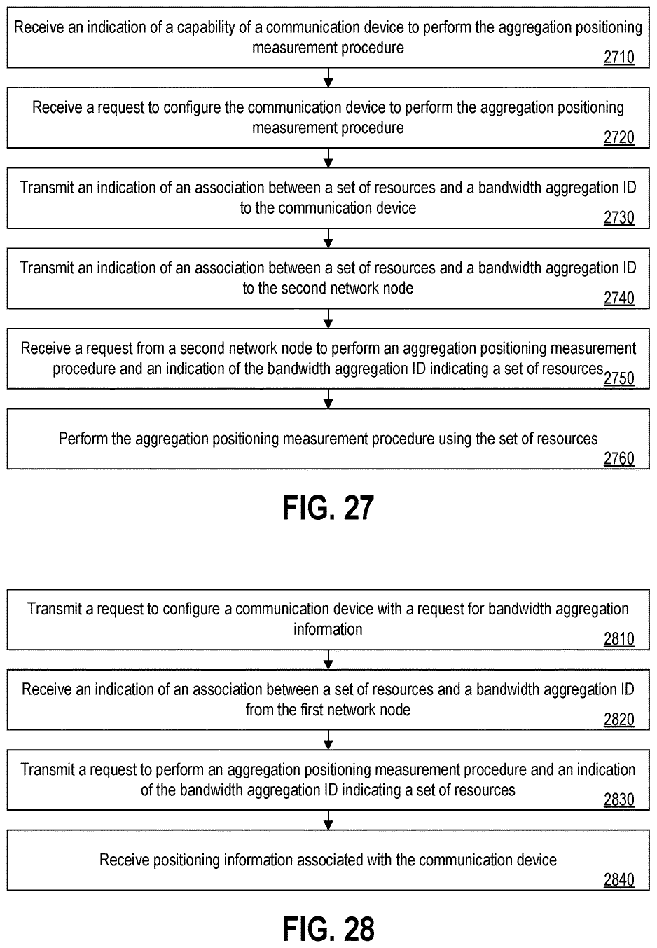

Operations of the RAN node 3100 (implemented using the structure of FIG. 31) will now be discussed with reference to the flow chart of FIGS. 27-28 according to some embodiments of inventive concepts. For example, modules may be stored in memory 3104 of FIG. 31, and these modules may provide instructions so that when the instructions of a module are executed by respective RAN node processing circuitry 3102, RAN node 3100 performs respective operations of the flow chart.

FIG. 27 illustrates an example of a first network node in a communications network that includes a communication device and a second network node. In some embodiments, the second network node is configured to provide a location management function, LMF. In additional or alternative embodiments, the first network node includes a distributed unit and a central unit.

At block 2710, processing circuitry 3102 receives, via communication interface 3106, an indication of a capability of the communication device to perform an aggregation positioning measurement procedure. In some embodiments, a new radio positioning protocol A, NRPPA, positioning information request is received that includes the indication of the capability of the communication device to perform the aggregation positioning measurement procedure At block 2720, processing circuitry 3102 receives, via communication interface 3106, a request to configure the communication device with a request for bandwidth aggregation information.

At block 2730, processing circuitry 3102 transmits, via communication interface 3106, an indication of an association between a set of resources and a bandwidth aggregation ID to the communication device.

At block 2740, processing circuitry 3102 transmits, via communication interface 3106, an indication of the bandwidth aggregation ID and the set of resources associated with the aggregation ID to the second network node. In some embodiments, the first network node provides the second network with an indication of a plurality of bandwidth aggregation IDs and an indication of a set of resources associated with each bandwidth aggregation ID of the plurality of bandwidth aggregation IDs.

In additional or alternative embodiments, a NRPPA positioning information response is transmitted and includes the indication of the bandwidth aggregation ID and the set of resources associated with the bandwidth aggregation ID.

At block 2750, processing circuitry 3102 receives, via communication interface 3106, a request from the second network node to perform an aggregation positioning measurement procedure and an indication of the bandwidth aggregation ID indicating a set of resources. In some embodiments, aNRPPA measurement request message is received in block 2750 and includes the request from the LMF.

At block 2760, processing circuitry 3102 performs the aggregation positioning measurement procedure using the set of resources. In some embodiments, performing the aggregation positioning measurement procedure includes transmitting instructions to the communication device to perform the aggregation positioning measurement procedure and an indication of the bandwidth aggregation ID. In some examples, transmitting the instructions to the communication device includes transmitting instructions to cause the communication device to transmit a plurality of sounding reference signals, SRS, in multiple carriers using the set of resources.

In additional or alternative embodiments, performing the aggregation positioning measurement procedure includes transmitting a positioning report to the second network node. The positioning reporting can include positioning measurements associated with the communication device and an indication of whether the positioning measurements were obtained using aggregation bandwidth.

In additional or alternative embodiments, performing the positioning measurement procedure includes transmitting the bandwidth aggregation ID to a neighboring network node.

FIG. 28 illustrates an example of a second network node in a communications network that includes a communication device and a first network node. In some embodiments, the second network node is configured to provide a location management function, LMF. In additional or alternative embodiments, the first network node includes a distributed unit and a central unit.

At block 2810, processing circuitry 3102 transmits, via communication interface 3106, a request to configure a communication device to with a request for bandwidth aggregation information.

At block 2820, processing circuitry 3102 receives, via communication interface 3106, an indication of an association between a set of resources and a bandwidth aggregation ID from the first network node. In some embodiments, the first network node provides the second network with an indication of a plurality of aggregation IDs and an indication of a set of resources associated with each bandwidth aggregation ID of the plurality of bandwidth aggregation IDs.

In additional or alternative embodiments, a NRPPA positioning information response is received and includes the indication of the bandwidth aggregation ID and the set of resources associated with the bandwidth aggregation ID.

At block 2830, processing circuitry 3102 transmits, via communication interface 3106, a request to perform an aggregation positioning measurement procedure and an indication of the bandwidth aggregation ID.

At block 2840, processing circuitry 3102 receives, via communication interface 3106, positioning information associated with the communication device. In some embodiments, the set of resources includes aggregation sounding reference signal, SRS, resources. The bandwidth aggregation information includes aggregation measurements associated with the SRS resources.

In additional or alternative embodiments, receiving the positioning information includes receiving a positioning report from the first network node. The positioning report can include positioning measurements associated with the communication device and an indication of whether the positioning measurements were obtained using aggregation bandwidth.

Various operations from the flow chart of FIGS. 27-28 may be optional with respect to some embodiments of RAN nodes and related methods.

Example Embodiments are described below.

Embodiment 1. A method of operating a communication device in a communications network that includes a network node, the method comprising:
receiving (2630) a message from the network node, the message including a request to perform an aggregation positioning measurement procedure and an indication of an aggregation identifier, ID associated with a set of resources to be used as part of the aggregation positioning measurement procedure;
determining (2640) the set of resources based on the aggregation ID; a
performing (2650) the aggregation positioning measurement procedure using the set of resources.

Embodiment 2. The method of Embodiment 1, wherein performing the positioning measurement procedure comprises:
transmitting a plurality of sounding reference signals, SRS, in multiple carriers using the set of resources.

Embodiment 3. The method of any of Embodiments 1-2, wherein performing the positioning measurement procedure comprises:
transmitting positional measurements to a second network node configured to provide a location management function, LMF.

Embodiment 4. The method of any of Embodiments 1-3, wherein performing the positioning measurement procedure comprises:
determining that the communication device will have sufficient coverage to perform the aggregation positioning measurement procedure.

Embodiment 5. The method of any of Embodiments 1-4, further comprising:
prior to receiving the message, transmitting (2610) an indication of a capability of the communication device to perform the aggregation positioning measurement procedure.

Embodiment 6. The method of any of Embodiments 1-5, further comprising:
prior to receiving the message, receiving (2620) a radio resource control, RRC, message from the network node including an indication of the set of resources associated with the aggregation ID.

Embodiment 7. A method of operating a first network node in a communications network that includes a communication device and a second network node, the method comprising:
receiving (2750) a message from the second network node, the message including a request for aggregation positioning information associated with the communication device and an aggregation identifier, ID, indicating a set of resources to be used to determine the aggregation positioning information; and
performing (2760) an aggregation positioning measurement procedure using the set of resources.

Embodiment 8. The method of Embodiment 7, wherein performing the aggregation positioning measurement procedure comprises transmitting instructions to the communication device to perform the aggregation positioning measurement procedure and an indication of the aggregation ID.

Embodiment 9. The method of Embodiment 8, wherein transmitting the instructions to the communication device comprises:
transmitting instructions to cause the communication device to transmit a plurality of sounding reference signals, SRS, in multiple carriers using the set of resources.

Embodiment 10. The method of any of Embodiments 7-9, wherein performing the aggregation positioning measurement procedure comprises transmitting a positioning report to the second network node, the positioning reporting including positioning measurements associated with the communication device and an indication of whether the positioning measurements were obtained using aggregation bandwidth.

Embodiment 11. The method of any of Embodiments 7-10, wherein performing the positioning measurement procedure comprises transmitting the aggregation ID to a neighboring network node.

Embodiment 12. The method of any of Embodiments 7-11, wherein the message comprises a third message, the method further comprising:
receiving (2720) a first message from the second network node, the first message including a request to configure the communication device to gather aggregation positioning information; and
transmitting (2740) a second message to the second network node, the second message including an indication of the aggregation ID and the set of resources associated with the aggregation ID.

Embodiment 13. The method of Embodiment 12, wherein the second message includes an indication of a plurality of aggregation IDs and an indication of a set of resources associated with each aggregation ID of the plurality of aggregation IDs.

Embodiment 14. The method of any of Embodiments 12-13, wherein the first message comprises a new radio positioning protocol A, NRPPA, positioning information request,
wherein the second message comprises a NRPPA positioning information response, and
wherein the third message includes a NRPPA measurement request message.

Embodiment 15. The method of any of Embodiments 7-14, further comprising:
prior to receiving the message, receiving (2710) an indication of a capability of the communication device to perform the aggregation positioning measurement procedure.

Embodiment 16. The method of any of Embodiments 7-15, further comprising:
prior to receiving the message, transmitting (2730) a radio resource control, RRC, message to the communication device including an indication of the set of resources associated with the aggregation ID.

Embodiment 17. The method of any of Embodiments 7-16, wherein the second network node is configured to provide a location management function, LMF, and wherein the first network node comprises a distributed unit and a central unit.

Embodiment 18. A method of operating a second network node in a communications network that includes a communication device and a first network node, the method comprising:
transmitting (2830) a message to the first network node, the message including a request for aggregation positioning information associated with the communication device and an aggregation identifier, ID, indicating a set of resources to be used to determine the aggregation positioning information; and
responsive to transmitting the message, receiving (2840) positioning information associated with the communication device.

Embodiment 19. The method of Embodiment 18, wherein the set of resources comprises aggregation sounding reference signal, SRS, resources, and
wherein the aggregation positioning information comprises aggregation measurements associated with the SRS resources.

Embodiment The method of any of Embodiments 18-19, wherein the message comprises a third message,
the method further comprising:
   transmitting (2810) a first message to the first network node, the first message including a request to configure the communication device to gather aggregation positioning information; and
   receiving (2820) a second message from the first network node, the second message including an indication of the aggregation ID and the set of resources associated with the aggregation ID.

Embodiment 21. The method of Embodiment 20, wherein the second message includes an indication of a plurality of aggregation IDs and an indication of a set of resources associated with each aggregation ID of the plurality of aggregation IDs.

Embodiment 22. The method of any of Embodiments 20-21, wherein the first message comprises a new radio positioning protocol A, NRPPA, positioning information request,
wherein the second message comprises a NRPPA positioning information response, and
wherein the third message includes a NRPPA measurement request message.

Embodiment 23. The method of any of Embodiments 18-22, wherein receiving the positioning information comprises receiving a positioning report from the first network node, the positioning reporting including positioning measurements associated with the communication device and an indication of whether the positioning measurements were obtained using aggregation bandwidth.

Embodiment 24. The method of any of Embodiments 18-23, wherein the second network node is configured to provide a location management function, LMF.

Embodiment 25. A communication device (3000), the communication device comprising:
processing circuitry (3002); and
memory (3010) coupled to the processing circuitry and having instructions stored therein that are executable by the processing circuitry to cause the communication device to perform operations comprising any of the operations of Embodiments 1-6.

Embodiment 26. A computer program comprising program code to be executed by processing circuitry (3002) of a communication device (3000), whereby execution of the program code causes the communication device to perform operations comprising any operations of Embodiments 1-6.

Embodiment 27. A computer program product comprising a non-transitory storage medium (3010) including program code to be executed by processing circuitry (3002) of a communication device (3000), whereby execution of the program code causes the entity to perform operations comprising any operations of Embodiments 1-6.

Embodiment 28. A non-transitory computer-readable medium having instructions stored therein that are executable by processing circuitry (3002) of an communication device (3000) to cause the communication device to perform operations comprising any of the operations of Embodiments 1-6.

Embodiment 29. A network node (3100), the network node comprising: processing circuitry (3102); and memory (3104) coupled to the processing circuitry and having instructions stored therein that are executable by the processing circuitry to cause the network node to perform operations comprising any of the operations of Embodiments 7-24.

Embodiment 30. A computer program comprising program code to be executed by processing circuitry (3102) of a network node (3100), whereby execution of the program code causes the network node to perform operations comprising any operations of Embodiments 7-24.

Embodiment 31. A computer program product comprising a non-transitory storage medium (3104) including program code to be executed by processing circuitry (3102) of a network node (3100), whereby execution of the program code causes the network node to perform operations comprising any operations of Embodiments 7-24.

Embodiment 32. A non-transitory computer-readable medium having instructions stored therein that are executable by processing circuitry (3102) of a network node (3100) to cause the network node to perform operations comprising any of the operations of Embodiments 7-24.

Embodiment 33. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   receiving (2730) a message from the second network node, the message including a request for aggregation positioning information associated with the communication device and an aggregation identifier, ID, indicating a set of resources to be used to determine the aggregation positioning information; and
   performing (2740) an aggregation positioning measurement procedure using the set of resources.

Embodiment 34. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 35. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   receiving (2730) a message from the second network node, the message including a request for aggregation positioning information associated with the communication device and an aggregation identifier, ID, indicating a set of resources to be used to determine the aggregation positioning information; and
   performing (2740) an aggregation positioning measurement procedure using the set of resources.

Embodiment 36. The method of the previous embodiment, further comprising, at the network node, transmitting the user data provided by the host for the UE.

Embodiment 37. The method of any of the previous 2 embodiments, wherein the user data is provided at the host by executing a host application that interacts with a client application executing on the UE, the client application being associated with the host application.

Embodiment 38. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   receiving (2730) a message from the second network node, the message including a request for aggregation positioning information associated with the communication device and an aggregation identifier, ID, indicating a set of resources to be used to determine the aggregation positioning information; and
   performing (2740) an aggregation positioning measurement procedure using the set of resources.

Embodiment 39. The communication system of the previous embodiment, further comprising:
the network node; and/or
the user equipment.

Embodiment 40. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 41. A host configured to operate in a communication system to provide an over-the-top (OTT) service, the host comprising:
processing circuitry configured to initiate receipt of user data; an
a network interface configured to receive the user data from a network node in a cellular network, the network node having a communication interface and processing circuitry, the processing circuitry of the network node configured to perform the following operations to receive the user data from the UE for the host:
   receiving (2730) a message from the second network node, the message including a request for aggregation positioning information associated with the communication device and an aggregation identifier, ID, indicating a set of resources to be used to determine the aggregation positioning information; and
   performing (2740) an aggregation positioning measurement procedure using the set of resources.

Embodiment 42. The host of the previous 2 embodiments, wherein:
the processing circuitry of the host is configured to execute a host application, thereby providing the user data; and
the host application is configured to interact with a client application executing on the UE, the client application being associated with the host application.

Embodiment 43. The host of the any of the previous 2 embodiments, wherein the initiating receipt of the user data comprises requesting the user data.

Embodiment 44. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   receiving (2730) a message from the second network node, the message including a request for aggregation positioning information associated with the communication device and an aggregation identifier, ID, indicating a set of resources to be used to determine the aggregation positioning information; and
   performing (2740) an aggregation positioning measurement procedure using the set of resources.

Embodiment 45. The method of the previous embodiment, further comprising at the network node, transmitting the received user data to the host.

Embodiment 46. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   receiving (2630) a message from the network node, the message including a request to perform an aggregation positioning measurement procedure and an indication of an aggregation identifier, ID associated with a set of resources to be used as part of the aggregation positioning measurement procedure;
   determining (2640) the set of resources based on the aggregation ID; and
   performing (2650) the aggregation positioning measurement procedure using the set of resources.

Embodiment 47. The host of the previous embodiment, wherein the cellular network further includes a network node configured to communicate with the UE to transmit the user data to the UE from the host.

Embodiment 48. The host of the previous 2 embodiments, wherein:
the processing circuitry of the host is configured to execute a host application, thereby providing the user data; and
the host application is configured to interact with a client application executing on the UE, the client application being associated with the host application.

Embodiment 49. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
   receiving (2630) a message from the network node, the message including a request to perform an aggregation positioning measurement procedure and an indication of an aggregation identifier, ID associated with a set of resources to be used as part of the aggregation positioning measurement procedure;
   determining (2640) the set of resources based on the aggregation ID; and
   performing (2650) the aggregation positioning measurement procedure using the set of resources.

Embodiment 50. The method of the previous embodiment, further comprising:
at the host, executing a host application associated with a client application executing on the UE to receive the user data from the UE.

Embodiment 51. The method of the previous embodiment, further comprising:
at the host, transmitting input data to the client application executing on the UE, the input data being provided by executing the host application,
wherein the user data is provided by the client application in response to the input data from the host application.

Embodiment 52. A host configured to operate in a communication system to provide an over-the-top (OTT) service, the host comprising:

processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   receiving (2630) a message from the network node, the message including a request to perform an aggregation positioning measurement procedure and an indication of an aggregation identifier, ID associated with a set of resources to be used as part of the aggregation positioning measurement procedure;
   determining (2640) the set of resources based on the aggregation ID; and
   performing (2650) the aggregation positioning measurement procedure using the set of resources.

Embodiment 53. The host of the previous embodiment, wherein the cellular network further includes a network node configured to communicate with the UE to transmit the user data from the UE to the host.

Embodiment 54. The host of the previous 2 embodiments, wherein:
the processing circuitry of the host is configured to execute a host application, thereby providing the user data; and
the host application is configured to interact with a client application executing on the UE, the client application being associated with the host application.

Embodiment 55. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
   receiving (2630) a message from the network node, the message including a request to perform an aggregation positioning measurement procedure and an indication of an aggregation identifier, ID associated with a set of resources to be used as part of the aggregation positioning measurement procedure;
   determining (2640) the set of resources based on the aggregation ID; and
   performing (2650) the aggregation positioning measurement procedure using the set of resources.

Embodiment 56. The method of the previous embodiment, further comprising:
at the host, executing a host application associated with a client application executing on the UE to receive the user data from the UE.

Embodiment 57. The method of the previous embodiments, further comprising:
at the host, transmitting input data to the client application executing on the UE, the input data being provided by executing the host application,
wherein the user data is provided by the client application in response to the input data from the host application.

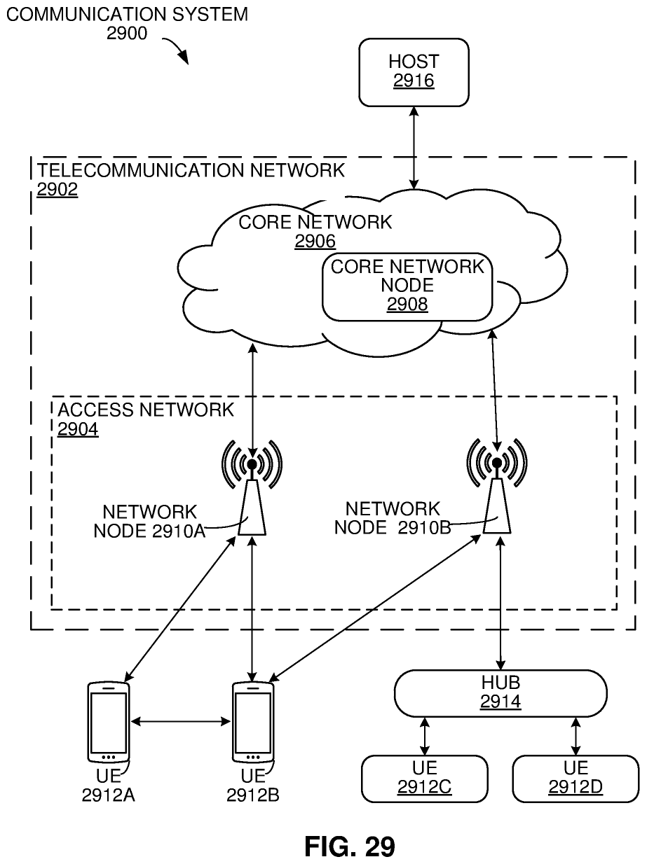

FIG. 29 shows an example of a communication system 2900 in accordance with some embodiments.

In the example, the communication system 2900 includes a telecommunication network 2902 that includes an access network 2904, such as a radio access network (RAN), and a core network 2906, which includes one or more core network nodes 2908. The access network 2904 includes one or more access network nodes, such as network nodes 2910a and 2910b (one or more of which may be generally referred to as network nodes 2910), or any other similar 3rd Generation Partnership Project (3GPP) access node or non-3GPP access point. Moreover, as will be appreciated by those of skill in the art, the network nodes 2910 are not necessarily limited to an implementation in which a radio portion and a baseband portion are supplied and integrated by a single vendor. Thus, it will be understood that the network nodes 2910 may include disaggregated implementations or portions thereof. For example, in some embodiments, the telecommunication network 2902 includes one or more Open-RAN (ORAN) network nodes. An ORAN network node is a node in the telecommunication network 2902 that supports an ORAN specification (e.g., a specification published by the O-RAN Alliance, or any similar organization) and may operate alone or together with other nodes to implement one or more functionalities of any node in the telecommunication network 2902, including one or more network nodes 2910 and/or core network nodes 2908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 2910 facilitate direct or indirect connection of user equipment (UE), such as by connecting wireless devices 2912a, 2912b, 2912c, and 2912d (one or more of which may be generally referred to as UEs 2912) to the core network 2906 over one or more wireless connections. The network nodes 2910 facilitate direct or indirect connection of user equipment (UE), such as by connecting UEs 2912a, 2912b, 2912c, and 2912d (one or more of which may be generally referred to as UEs 2912) to the core network 2906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2900 may include any number of wired or wireless networks, network nodes, UEs, and/or any other components or systems that may facilitate or participate in the communication of data and/or signals whether via wired or wireless connections. The communication system 2900 may include and/or interface with any type of communication, telecommunication, data, cellular, radio network, and/or other similar type of system.

The UEs 2912 may be any of a wide variety of communication devices, including wireless devices arranged, configured, and/or operable to communicate wirelessly with the network nodes 2910 and other communication devices. Similarly, the network nodes 2910 are arranged, capable, configured, and/or operable to communicate directly or indirectly with the UEs 2912 and/or with other network nodes or equipment in the telecommunication network 2902 to enable and/or provide network access, such as wireless network access, and/or to perform other functions, such as administration in the telecommunication network 2902.

In the depicted example, the core network 2906 connects the network nodes 2910 to one or more hosts, such as host 2916. These connections may be direct or indirect via one or more intermediary networks or devices. In other examples, network nodes may be directly coupled to hosts. The core network 2906 includes one more core network nodes (e.g., core network node 2908) that are structured with hardware and software components. Features of these components may be substantially similar to those described with respect to the UEs, network nodes, and/or hosts, such that the descriptions thereof are generally applicable to the corresponding components of the core network node 2908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2916 may be under the ownership or control of a service provider other than an operator or provider of the access network 2904 and/or the telecommunication network 2902, and may be operated by the service provider or on behalf of the service provider. The host 2916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2900 of FIG. 29 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2902 is a cellular network that implements 3GPP standardized features. Accordingly, the telecommunications network 2902 may support network slicing to provide different logical networks to different devices that are connected to the telecommunication network 2902. For example, the telecommunications network 2902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2912 are configured to transmit and/or receive information without direct human interaction. For instance, a UE may be designed to transmit information to the access network 2904 on a predetermined schedule, when triggered by an internal or external event, or in response to requests from the access network 2904. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2914 communicates with the access network 2904 to facilitate indirect communication between one or more UEs (e.g., UE 2912c and/or 2912d) and network nodes (e.g., network node 2910b). In some examples, the hub 2914 may be a controller, router, content source and analytics, or any of the other communication devices described herein regarding UEs. For example, the hub 2914 may be a broadband router enabling access to the core network 2906 for the UEs. As another example, the hub 2914 may be a controller that sends commands or instructions to one or more actuators in the UEs. Commands or instructions may be received from the UEs, network nodes 2910, or by executable code, script, process, or other instructions in the hub 2914. As another example, the hub 2914 may be a data collector that acts as temporary storage for UE data and, in some embodiments, may perform analysis or other processing of the data. As another example, the hub 2914 may be a content source. For example, for a UE that is a VR headset, display, loudspeaker or other media delivery device, the hub 2914 may retrieve VR assets, video, audio, or other media or data related to sensory information via a network node, which the hub 2914 then provides to the UE either directly, after performing local processing, and/or after adding additional local content. In still another example, the hub 2914 acts as a proxy server or orchestrator for the UEs, in particular in if one or more of the UEs are low energy IoT devices.

The hub 2914 may have a constant/persistent or intermittent connection to the network node 2910b. The hub 2914 may also allow for a different communication scheme and/or schedule between the hub 2914 and UEs (e.g., UE 2912c and/or 2912d), and between the hub 2914 and the core network 2906. In other examples, the hub 2914 is connected to the core network 2906 and/or one or more UEs via a wired connection. Moreover, the hub 2914 may be configured to connect to an M2M service provider over the access network 2904 and/or to another UE over a direct connection. In some scenarios, UEs may establish a wireless connection with the network nodes 2910 while still connected via the hub 2914 via a wired or wireless connection. In some embodiments, the hub 2914 may be a dedicated hub-that is, a hub whose primary function is to route communications to/from the UEs from/to the network node 2910b. In other embodiments, the hub 2914 may be a non-dedicated hub-that is, a device which is capable of operating to route communications between the UEs and network node 2910b, but which is additionally capable of operating as a communication start and/or end point for certain data channels.

FIG. 30 shows a UE 3000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 3000 includes processing circuitry 3002 that is operatively coupled via a bus 3004 to an input/output interface 3006, a power source 3008, a memory 3010, a communication interface 3012, and/or any other component, or any combination thereof. Certain UEs may utilize all or a subset of the components shown in FIG. 30. The level of integration between the components may vary from one UE to another UE. Further, certain UEs may contain multiple instances of a component, such as multiple processors, memories, transceivers, transmitters, receivers, etc.

The processing circuitry 3002 is configured to process instructions and data and may be configured to implement any sequential state machine operative to execute instructions stored as machine-readable computer programs in the memory 3010. The processing circuitry 3002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 3002 may include multiple central processing units (CPUs).

In the example, the input/output interface 3006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 3000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3008 is structured as a battery or battery pack. Other types of power sources, such as an external power source (e.g., an electricity outlet), photovoltaic device, or power cell, may be used. The power source 3008 may further include power circuitry for delivering power from the power source 3008 itself, and/or an external power source, to the various parts of the UE 3000 via input circuitry or an interface such as an electrical power cable. Delivering power may be, for example, for charging of the power source 3008. Power circuitry may perform any formatting, converting, or other modification to the power from the power source 3008 to make the power suitable for the respective components of the UE 3000 to which power is supplied.

The memory 3010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 3010 includes one or more application programs 3014, such as an operating system, web browser application, a widget, gadget engine, or other application, and corresponding data 3016. The memory 3010 may store, for use by the UE 3000, any of a variety of various operating systems or combinations of operating systems.

The memory 3010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 3010 may allow the UE 3000 to access instructions, application programs and the like, stored on transitory or non-transitory memory media, to off-load data, or to upload data. An article of manufacture, such as one utilizing a communication system may be tangibly embodied as or in the memory 3010, which may be or comprise a device-readable storage medium.

The processing circuitry 3002 may be configured to communicate with an access network or other network using the communication interface 3012. The communication interface 3012 may comprise one or more communication subsystems and may include or be communicatively coupled to an antenna 3022. The communication interface 3012 may include one or more transceivers used to communicate, such as by communicating with one or more remote transceivers of another device capable of wireless communication (e.g., another UE or a network node in an access network). Each transceiver may include a transmitter 3018 and/or a receiver 3020 appropriate to provide network communications (e.g., optical, electrical, frequency allocations, and so forth). Moreover, the transmitter 3018 and receiver 3020 may be coupled to one or more antennas (e.g., antenna 3022) and may share circuit components, software or firmware, or alternatively be implemented separately.

In the illustrated embodiment, communication functions of the communication interface 3012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 3012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 3000 shown in FIG. 30.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 31 shows a network node 3100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3100 includes a processing circuitry 3102, a memory 3104, a communication interface 3106, and a power source 3108. The network node 3100 may be composed of multiple physically separate components (e.g., a NodeB component and a RNC component, or a BTS component and a BSC component, etc.), which may each have their own respective components. In certain scenarios in which the network node 3100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3100 may be configured to support multiple radio access technologies (RATs). In such embodiments, some components may be duplicated (e.g., separate memory 3104 for different RATs) and some components may be reused (e.g., a same antenna 3110 may be shared by different RATs). The network node 3100 may also include multiple sets of the various illustrated components for different wireless technologies integrated into network node 3100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3100.

The processing circuitry 3102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3100 components, such as the memory 3104, to provide network node 3100 functionality.

In some embodiments, the processing circuitry 3102 includes a system on a chip (SOC). In some embodiments, the processing circuitry 3102 includes one or more of radio frequency (RF) transceiver circuitry 3112 and baseband processing circuitry 3114. In some embodiments, the radio frequency (RF) transceiver circuitry 3112 and the baseband processing circuitry 3114 may be on separate chips (or sets of chips), boards, or units, such as radio units and digital units. In alternative embodiments, part or all of RF transceiver circuitry 3112 and baseband processing circuitry 3114 may be on the same chip or set of chips, boards, or units.

The memory 3104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3102. The memory 3104 may store any suitable instructions, data, or information, including a computer program, software, an application including one or more of logic, rules, code, tables, and/or other instructions capable of being executed by the processing circuitry 3102 and utilized by the network node 3100. The memory 3104 may be used to store any calculations made by the processing circuitry 3102 and/or any data received via the communication interface 3106. In some embodiments, the processing circuitry 3102 and memory 3104 is integrated.

The communication interface 3106 is used in wired or wireless communication of signaling and/or data between a network node, access network, and/or UE. As illustrated, the communication interface 3106 comprises port(s)/terminal(s) 3116 to send and receive data, for example to and from a network over a wired connection. The communication interface 3106 also includes radio front-end circuitry 3118 that may be coupled to, or in certain embodiments a part of, the antenna 3110. Radio front-end circuitry 3118 comprises filters 3120 and amplifiers 3122. The radio front-end circuitry 3118 may be connected to an antenna 3110 and processing circuitry 3102. The radio front-end circuitry may be configured to condition signals communicated between antenna 3110 and processing circuitry 3102. The radio front-end circuitry 3118 may receive digital data that is to be sent out to other network nodes or UEs via a wireless connection. The radio front-end circuitry 3118 may convert the digital data into a radio signal having the appropriate channel and bandwidth parameters using a combination of filters 3120 and/or amplifiers 3122. The radio signal may then be transmitted via the antenna 3110. Similarly, when receiving data, the antenna 3110 may collect radio signals which are then converted into digital data by the radio front-end circuitry 3118. The digital data may be passed to the processing circuitry 3102. In other embodiments, the communication interface may comprise different components and/or different combinations of components.

In certain alternative embodiments, the network node 3100 does not include separate radio front-end circuitry 3118, instead, the processing circuitry 3102 includes radio front-end circuitry and is connected to the antenna 3110. Similarly, in some embodiments, all or some of the RF transceiver circuitry 3112 is part of the communication interface 3106. In still other embodiments, the communication interface 3106 includes one or more ports or terminals 3116, the radio front-end circuitry 3118, and the RF transceiver circuitry 3112, as part of a radio unit (not shown), and the communication interface 3106 communicates with the baseband processing circuitry 3114, which is part of a digital unit (not shown).

The antenna 3110 may include one or more antennas, or antenna arrays, configured to send and/or receive wireless signals. The antenna 3110 may be coupled to the radio front-end circuitry 3118 and may be any type of antenna capable of transmitting and receiving data and/or signals wirelessly. In certain embodiments, the antenna 3110 is separate from the network node 3100 and connectable to the network node 3100 through an interface or port.

The antenna 3110, communication interface 3106, and/or the processing circuitry 3102 may be configured to perform any receiving operations and/or certain obtaining operations described herein as being performed by the network node. Any information, data and/or signals may be received from a UE, another network node and/or any other network equipment.

Similarly, the antenna 3110, the communication interface 3106, and/or the processing circuitry 3102 may be configured to perform any transmitting operations described herein as being performed by the network node. Any information, data and/or signals may be transmitted to a UE, another network node and/or any other network equipment.

The power source 3108 provides power to the various components of network node 3100 in a form suitable for the respective components (e.g., at a voltage and current level needed for each respective component). The power source 3108 may further comprise, or be coupled to, power management circuitry to supply the components of the network node 3100 with power for performing the functionality described herein. For example, the network node 3100 may be connectable to an external power source (e.g., the power grid, an electricity outlet) via an input circuitry or interface such as an electrical cable, whereby the external power source supplies power to power circuitry of the power source 3108. As a further example, the power source 3108 may comprise a source of power in the form of a battery or battery pack which is connected to, or integrated in, power circuitry. The battery may provide backup power should the external power source fail.

Embodiments of the network node 3100 may include additional components beyond those shown in FIG. 31 for providing certain aspects of the network node's functionality, including any of the functionality described herein and/or any functionality necessary to support the subject matter described herein. For example, the network node 3100 may include user interface equipment to allow input of information into the network node 3100 and to allow output of information from the network node 3100. This may allow a user to perform diagnostic, maintenance, repair, and other administrative functions for the network node 3100.

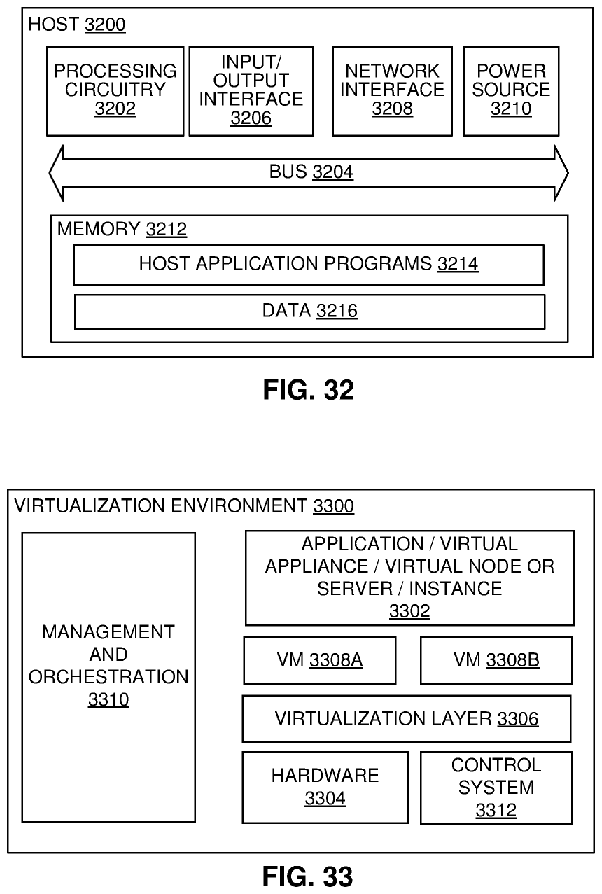

FIG. 32 is a block diagram of a host 3200, which may be an embodiment of the host 2916 of FIG. 29, in accordance with various aspects described herein. As used herein, the host 3200 may be or comprise various combinations hardware and/or software, including a standalone server, a blade server, a cloud-implemented server, a distributed server, a virtual machine, container, or processing resources in a server farm. The host 3200 may provide one or more services to one or more UEs.

The host 3200 includes processing circuitry 3202 that is operatively coupled via a bus 3204 to an input/output interface 3206, a network interface 3208, a power source 3210, and a memory 3212. Other components may be included in other embodiments. Features of these components may be substantially similar to those described with respect to the devices of previous figures, such as FIGS. 30 and 31, such that the descriptions thereof are generally applicable to the corresponding components of host 3200.

The memory 3212 may include one or more computer programs including one or more host application programs 3214 and data 3216, which may include user data, e.g., data generated by a UE for the host 3200 or data generated by the host 3200 for a UE. Embodiments of the host 3200 may utilize only a subset or all of the components shown. The host application programs 3214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3214 may also provide for user authentication and licensing checks and may periodically report health, routes, and content availability to a central node, such as a device in or on the edge of a core network. Accordingly, the host 3200 may select and/or indicate a different host for over-the-top services for a UE. The host application programs 3214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 33 is a block diagram illustrating a virtualization environment 3300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 3300 includes components defined by the O-RAN Alliance, such as an O-Cloud environment orchestrated by a Service Management and Orchestration Framework via an O-2 interface.

Applications 3302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3306 (also referred to as hypervisors or virtual machine monitors (VMMs)), provide VMs 3308a and 3308b (one or more of which may be generally referred to as VMs 3308), and/or perform any of the functions, features and/or benefits described in relation with some embodiments described herein. The virtualization layer 3306 may present a virtual operating platform that appears like networking hardware to the VMs 3308.

The VMs 3308 comprise virtual processing, virtual memory, virtual networking or interface and virtual storage, and may be run by a corresponding virtualization layer 3306. Different embodiments of the instance of a virtual appliance 3302 may be implemented on one or more of VMs 3308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3308 may be a software implementation of a physical machine that runs programs as if they were executing on a physical, non-virtualized machine. Each of the VMs 3308, and that part of hardware 3304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3308 on top of the hardware 3304 and corresponds to the application 3302.

Hardware 3304 may be implemented in a standalone network node with generic or specific components. Hardware 3304 may implement some functions via virtualization. Alternatively, hardware 3304 may be part of a larger cluster of hardware (e.g. such as in a data center or CPE) where many hardware nodes work together and are managed via management and orchestration 3310, which, among others, oversees lifecycle management of applications 3302. In some embodiments, hardware 3304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3312 which may alternatively be used for communication between hardware nodes and radio units.

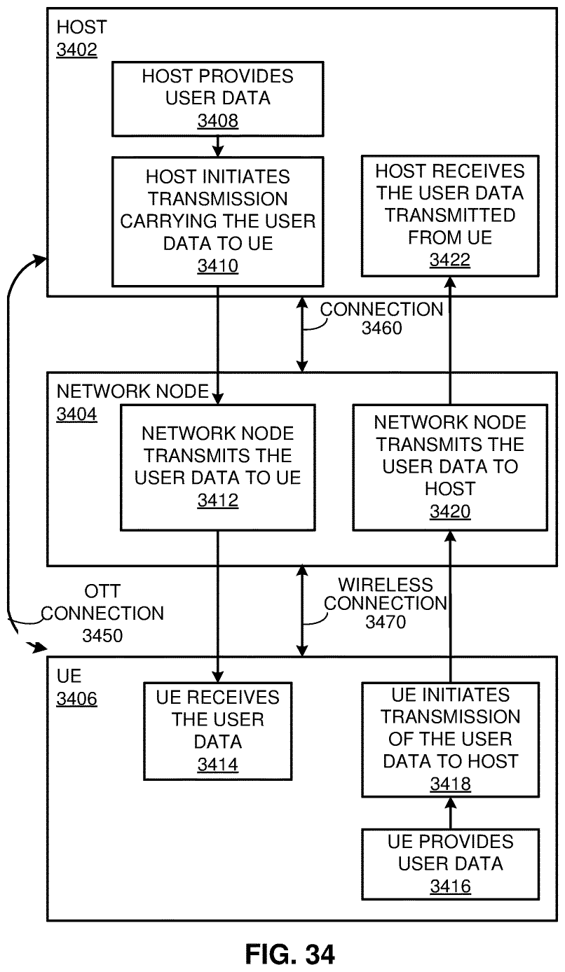

FIG. 34 shows a communication diagram of a host 3402 communicating via a network node 3404 with a UE 3406 over a partially wireless connection in accordance with some embodiments. Example implementations, in accordance with various embodiments, of the UE (such as a UE 2912a of FIG. 29 and/or UE 3000 of FIG. 30), network node (such as network node 2910a of FIG. 29 and/or network node 3100 of FIG. 31), and host (such as host 2916 of FIG. 29 and/or host 3200 of FIG. 32) discussed in the preceding paragraphs will now be described with reference to FIG. 34.

Like host 3200, embodiments of host 3402 include hardware, such as a communication interface, processing circuitry, and memory. The host 3402 also includes software, which is stored in or accessible by the host 3402 and executable by the processing circuitry. The software includes a host application that may be operable to provide a service to a remote user, such as the UE 3406 connecting via an over-the-top (OTT) connection 3450 extending between the UE 3406 and host 3402. In providing the service to the remote user, a host application may provide user data which is transmitted using the OTT connection 3450.

The network node 3404 includes hardware enabling it to communicate with the host 3402 and UE 3406. The connection 3460 may be direct or pass through a core network (like core network 2906 of FIG. 29) and/or one or more other intermediate networks, such as one or more public, private, or hosted networks. For example, an intermediate network may be a backbone network or the Internet.

The UE 3406 includes hardware and software, which is stored in or accessible by UE 3406 and executable by the UE's processing circuitry. The software includes a client application, such as a web browser or operator-specific “app” that may be operable to provide a service to a human or non-human user via UE 3406 with the support of the host 3402. In the host 3402, an executing host application may communicate with the executing client application via the OTT connection 3450 terminating at the UE 3406 and host 3402. In providing the service to the user, the UE's client application may receive request data from the host's host application and provide user data in response to the request data. The OTT connection 3450 may transfer both the request data and the user data. The UE's client application may interact with the user to generate the user data that it provides to the host application through the OTT connection 3450.

The OTT connection 3450 may extend via a connection 3460 between the host 3402 and the network node 3404 and via a wireless connection 3470 between the network node 3404 and the UE 3406 to provide the connection between the host 3402 and the UE 3406. The connection 3460 and wireless connection 3470, over which the OTT connection 3450 may be provided, have been drawn abstractly to illustrate the communication between the host 3402 and the UE 3406 via the network node 3404, without explicit reference to any intermediary devices and the precise routing of messages via these devices.

As an example of transmitting data via the OTT connection 3450, in step 3408, the host 3402 provides user data, which may be performed by executing a host application. In some embodiments, the user data is associated with a particular human user interacting with the UE 3406. In other embodiments, the user data is associated with a UE 3406 that shares data with the host 3402 without explicit human interaction. In step 3410, the host 3402 initiates a transmission carrying the user data towards the UE 3406. The host 3402 may initiate the transmission responsive to a request transmitted by the UE 3406. The request may be caused by human interaction with the UE 3406 or by operation of the client application executing on the UE 3406. The transmission may pass via the network node 3404, in accordance with the teachings of the embodiments described throughout this disclosure. Accordingly, in step 3412, the network node 3404 transmits to the UE 3406 the user data that was carried in the transmission that the host 3402 initiated, in accordance with the teachings of the embodiments described throughout this disclosure. In step 3414, the UE 3406 receives the user data carried in the transmission, which may be performed by a client application executed on the UE 3406 associated with the host application executed by the host 3402.

In some examples, the UE 3406 executes a client application which provides user data to the host 3402. The user data may be provided in reaction or response to the data received from the host 3402. Accordingly, in step 3416, the UE 3406 may provide user data, which may be performed by executing the client application. In providing the user data, the client application may further consider user input received from the user via an input/output interface of the UE 3406. Regardless of the specific manner in which the user data was provided, the UE 3406 initiates, in step 3418, transmission of the user data towards the host 3402 via the network node 3404. In step 3420, in accordance with the teachings of the embodiments described throughout this disclosure, the network node 3404 receives user data from the UE 3406 and initiates transmission of the received user data towards the host 3402. In step 3422, the host 3402 receives the user data carried in the transmission initiated by the UE 3406.

One or more of the various embodiments improve the performance of OTT services provided to the UE 3406 using the OTT connection 3450, in which the wireless connection 3470 forms the last segment. More precisely, the teachings of these embodiments may allow for indication of list of aggregated SRS to LMF to be able to judge the total bandwidth. The LMF can ask the measurements to be done on a specific bandwidth, without asking exactly the SRS resources to the TRP, which will save on signaling and reduce complexity. the TRP/gNB answers the LMF with the measurement and the list of SRS used for the measurement report In an example scenario, factory status information may be collected and analyzed by the host 3402. As another example, the host 3402 may process audio and video data which may have been retrieved from a UE for use in creating maps. As another example, the host 3402 may collect and analyze real-time data to assist in controlling vehicle congestion (e.g., controlling traffic lights). As another example, the host 3402 may store surveillance video uploaded by a UE. As another example, the host 3402 may store or control access to media content such as video, audio, VR or AR which it can broadcast, multicast or unicast to UEs. As other examples, the host 3402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3450 between the host 3402 and UE 3406, in response to variations in the measurement results. The measurement procedure and/or the network functionality for reconfiguring the OTT connection may be implemented in software and hardware of the host 3402 and/or UE 3406. In some embodiments, sensors (not shown) may be deployed in or in association with other devices through which the OTT connection 3450 passes; the sensors may participate in the measurement procedure by supplying values of the monitored quantities exemplified above, or supplying values of other physical quantities from which software may compute or estimate the monitored quantities. The reconfiguring of the OTT connection 3450 may include message format, retransmission settings, preferred routing etc. ; the reconfiguring need not directly alter the operation of the network node 3404. Such procedures and functionalities may be known and practiced in the art. In certain embodiments, measurements may involve proprietary UE signaling that facilitates measurements of throughput, propagation times, latency and the like, by the host 3402. The measurements may be implemented in that software causes messages to be transmitted, in particular empty or ‘dummy’ messages, using the OTT connection 3450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method of operating a second network node in a communications network that includes a communication device and a first network node, the method comprising:
transmitting a first message to the first network node, the first message including a request to configure the communication device with a request for bandwidth aggregation information; and
receiving a second message from the first network node, the second message including an indication of a bandwidth aggregation identifier, ID, and a set of resources associated with the bandwidth aggregation ID.

2. The method of claim 1, wherein the second message includes an indication of a plurality of bandwidth aggregation IDs and an indication of a set of resources associated with each bandwidth aggregation ID of the plurality of bandwidth aggregation IDs.

3-5. (canceled)

6. The method of claim 1, wherein the first message comprises a frequency 1 application protocol, F1AP, positioning information request,
wherein the second message comprises a F1AP positioning information response,

7. The method of claim 1, further comprising:
transmitting a third message to the first network node, the third message including a measurement request for bandwidth aggregation information associated with the communication device and a bandwidth aggregation identifier, ID, indicating a set of resources to be used to determine the bandwidth aggregation information; and
responsive to transmitting the third message, receiving measurement results including bandwidth aggregation information,
wherein receiving the measurement results comprises receiving a positioning report from the first network node, the positioning reporting including positioning measurements associated with the communication device and an indication of whether the positioning measurements were obtained using aggregation bandwidth.

8. A method of operating a second network node in a communications network that includes a communication device and a first network node, the method comprising:
transmitting a third message to the first network node, the third message including a measurement request for bandwidth aggregation information associated with the communication device and a bandwidth aggregation identifier, ID, indicating a set of resources to be used to determine the bandwidth aggregation information; and
responsive to transmitting the third message, receiving ) measurement results including bandwidth aggregation information.

9. The method of claim 8, wherein receiving the measurement results comprises receiving a positioning report from the first network node, the positioning reporting including positioning measurements associated with the communication device and an indication of whether the positioning measurements were obtained using aggregation bandwidth.

10. The method of claim 8, wherein the third message includes a NRPPA measurement request message.

11. (canceled)

12. The method of claim 8, wherein the third message comprises a F1AP measurement request message.

13. (canceled)

14. A method of operating a first network node in a communications network that includes a communication device and a second network node, the method comprising:
receiving a first message from the second network node, the first message including a request to configure the communication device with a request for bandwidth aggregation information; and
transmitting a second message to the second network node, the second message including an indication of a bandwidth aggregation identifier, ID, and a set of resources associated with the bandwidth aggregation ID.

15-19. (canceled)

20. The method of claim 14, further comprising:
prior to receiving the message, receiving an indication of a capability of the communication device to perform the aggregation positioning measurement procedure.

21-22. (canceled)

23. A method of operating a first network node in a communications network that includes a communication device and a second network node, the method comprising:
receiving a message from the second network node, the message including a measurement request for bandwidth aggregation information associated with the communication device and a bandwidth aggregation identifier, ID, indicating a set of resources to be used to determine the bandwidth aggregation information; and
performing an aggregation positioning measurement procedure using the set of resources.

24-27. (canceled)

28. The method of claim 23, wherein performing the aggregation positioning measurement procedure comprises transmitting a positioning report to the second network node, the positioning reporting including positioning measurements associated with the communication device and an indication of whether the positioning measurements were obtained using aggregation bandwidth.

29. The method of claim 23, wherein performing the positioning measurement procedure comprises transmitting the bandwidth aggregation ID to a neighboring network node.

30. A method of operating a communication device in a communications network that includes a network node, the method comprising:
receiving a message from the network node, the message including a request to perform an aggregation positioning measurement procedure and an indication of a bandwidth aggregation identifier, ID associated with a set of resources to be used as part of the aggregation positioning measurement procedure; and
performing the aggregation positioning measurement procedure using the set of resources.

31. The method of claim 30, further comprising:
determining the set of resources based on the bandwidth aggregation ID.

32. (canceled)

33. The method of claim 30, wherein the network node is a first network node,
wherein performing the positioning measurement procedure comprises:
transmitting positional measurements to a second network node configured to provide a location management function, LMF.

34. The method of claim 30, wherein performing the positioning measurement procedure comprises:
determining that the communication device will have sufficient coverage to perform the aggregation positioning measurement procedure.

35. The method of claim 30, further comprising:
prior to receiving the message, transmitting an indication of a capability of the communication device to perform the aggregation positioning measurement procedure.

36-42. (canceled)

43. The method of claim 14, wherein the set of resources comprises aggregation sounding reference signal, SRS, resources, and
wherein the bandwidth aggregation information comprises aggregation measurements associated with the SRS resources.

44. A communication device in a communications network that includes a network node, the communication device comprising a processor and a memory, the memory containing instructions executable by the processor whereby the communication device is operative to:
receive a message from the network node, the message including a request to perform an aggregation positioning measurement procedure and an indication of a bandwidth aggregation identifier, ID associated with a set of resources to be used as part of the aggregation positioning measurement procedure; and
perform the aggregation positioning measurement procedure using the set of resources.
